(19) United States
(12) Patent Application Publication
(10) Pub. No.: US 2009/0143131 A1
(43) Pub. Date: Jun. 4, 2009

(54) GAMING MACHINE ARRANGING SCATTER SYMBOL AND SPECIFIC AREA IN ARRANGEMENT AREA AND PLAYING METHOD THEREOF

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp.

(21) Appl. No.: 12/054,002

(22) Filed: Mar. 24, 2008

Related U.S. Application Data
(60) Provisional application No. 60/996,757, filed on Dec. 4, 2007.

(51) Int. Cl. A63F 13/00; A63F 9/24; G06F 19/00

(52) U.S. Cl. 463/20; 463/14; 463/43; 463/16

(57) ABSTRACT

In a bonus game, one or more scatter symbols 180 and zero or more specific areas 190 are displayed (arranged) in display windows 151 to 155 forming a matrix shape and a prize is awarded according to the one or more scatter symbols 180 displayed in the one or more arrangement areas in which the specific areas 190 are displayed, and the number of the scatter symbols 180 displayed in the display windows 151 to 155.

### CROSS REFERENCE TO RELATED APPLICATION

This application claims the benefit of U.S. provisional application No. 60/996,757, filed on Dec. 4, 2007.

### BACKGROUND OF THE INVENTION

1. Field of the Invention

The invention relates to a slot machine, a gaming machine, and a playing method thereof.

2. Description of Related Art

In a conventional slot machine, when a player inserts a game medium such as a coin or bill into an insertion slot of the gaming machine and presses a start button, symbols are scroll-displayed on a display mounted on a front of a cabinet and the symbols are then stopped automatically.

In such gaming machine, as disclosed in U.S. Pat. No. 6,604,999 B2 or U.S. Patent No. 2002065124A1, for example, when symbols stopped on a winning line constitute a predetermined combination, the predetermined numbers of game media are paid out as a win. In addition, when a certain symbol referred to as a scatter symbol is displayed on the display, the predetermined number of game media are paid out in accordance with the number of scatter symbols displayed, irrespective of the winning line.

In the conventional slot machines, a scatter symbol to be displayed on a display is randomly determined on the basis of a predetermined condition and then the determined scatter symbol is displayed on the display. However, the determined scatter symbol is just displayed, so that a player can expect the determination of the scatter symbol by seeing the scatter symbol displayed. Therefore, an entertainment characteristic is insufficient.

An object of the invention is to provide a gaming machine having an entertainment characteristic, which is not provided to the prior art, and a playing method thereof.

In addition, another object of the invention is to provide a gaming machine in which a situation of whether a payout is awarded is visually recognized, and a playing method thereof.

Further, still another object of the invention is to provide a gaming machine in which it is clearly recognized that a determination relating to an award of prize is separated from a determination of a scatter symbol, and a playing method thereof.

### SUMMARY OF THE INVENTION

A gaming machine of the invention includes: a display that has a matrix having one or more arrangement areas and arranges one or more scatter symbols and zero or more specific areas in the one or more arrangement areas; and a controller that is programmed to operate as described in the steps of (a1) to (a3). Specifically, the controller operates: (a1) to rearrange one or more scatter symbols based on a predetermined timing; (a2) to arrange zero or more specific areas based on a predetermined timing; and (a3) to award a prize according to the one or more scatter symbols rearranged in the one or more arrangement areas in which the zero or more specific areas are arranged, and the number of the scatter symbols rearranged in the one or more arrangement areas.

According to the above structure, in a display; one or more scatter symbols are rearranged in a matrix having one or more arrangement areas; zero or more specific areas are arranged in the one or more arrangement areas, based on a predetermined timing. A prize according to the one or more scatter symbols rearranged in the one or more arrangement areas in which the zero or more specific areas are arranged, and the number of the scatter symbols rearranged in the one or more arrangement areas is awarded.

Accordingly, by seeing the arrangement of the zero or more specific areas and the rearrangement of the one or more scatter symbols in the one or more arrangement areas in which the zero or more specific areas are arranged, a player can expect a prize based on the zero or more specific areas, separately from a prize resulting from the conventional arrangement of the one or more scatter symbols, so that a new entertainment characteristic can be provided.

A gaming machine of the invention includes: a display that has a matrix having one or more arrangement areas and arranges one or more scatter symbols and zero or more specific areas in the one or more arrangement areas; the one or more scatter symbols each indicating a prize of different magnitude; and a controller that is programmed to operate as described in the steps of (b1) to (b4). Specifically, the controller operates: (b1) to rearrange the one or more scatter symbols based on a predetermined timing; (b2) to arrange the zero or more specific areas based on a predetermined timing; (b3) to replace the one or more scatter symbols rearranged in the one or more arrangement areas in which the zero or more specific areas are arranged, with one or more scatter symbols indicating one or more prizes of predetermined magnitudes; and (b4) to award a prize according to the number of the scatter symbols arranged in the one or more arrangement areas.

According to the above structure, in a display, the one or more scatter symbols each indicating a prize of different magnitude are rearranged in a matrix having one or more arrangement areas and zero or more specific areas are arranged in the one or more arrangement areas based on a predetermined timing. The one or more scatter symbols rearranged in the one or more arrangement areas in which the zero or more specific areas are arranged, are replaced with one or more scatter symbols indicating one or more prizes of predetermined magnitude and a prize according to the number of the scatter symbols arranged in the one or more arrangement areas is awarded.

Accordingly, by seeing the arrangement of the zero or more specific areas and the rearrangement of the one or more scatter symbols in the one or more arrangement areas in which the zero or more specific areas are arranged, a player can expect a new prize resulting from the replacement of the one or more scatter symbols in the zero or more specific areas, so that a new entertainment characteristic can be provided.

A gaming machine of the invention includes: a display that has a matrix having one or more arrangement areas and arranges one or more scatter symbols; zero or more rate symbols each of which indicating a prize rate and zero or more specific areas in the one or more arrangement areas; and a controller that is programmed to operate as described in the steps of (c1) to (c3). Specifically, the controller operates: (c1) to rearrange the one or more scatter symbols and the zero or more rate symbols based on a predetermined timing; (c2) to arrange the zero or more specific areas based on a predetermined timing; and (c3) to award a prize according to prize rates, which are indicated by the zero or more rate symbols rearranged in the one or more arrangement areas in which the zero or more specific areas are arranged, and the number of the scatter symbols rearranged in the one or more arrangement areas.

According to the above structure, in a display, one or more scatter symbols, and zero or more rate symbols each of which indicating a prize rate, are rearranged in a matrix having one or more arrangement areas and zero or more specific areas are arranged in the one or more arrangement areas based on a predetermined timing. A prize according to prize rates, which are indicated by the zero or more rate symbols rearranged in the one or more arrangement areas in which the zero or more specific areas are arranged, and the number of the scatter symbols rearranged in the one or more arrangement areas is awarded.

Accordingly, by seeing the arrangement of the zero or more specific areas and the rearrangement of the zero or more rate symbols in the arrangement areas in which the zero or more specific areas are arranged, a player can expect a new prize according to prize rates indicated by the zero or more rate symbols in the zero or more specific areas, so that a new entertainment characteristic can be provided.

A gaming machine of the invention includes: a display that has a matrix having one or more arrangement areas and arranges one or more scatter symbols and zero or more specific areas in the one or more arrangement areas; and a controller that is programmed to operate as described in the steps of (d1) to (d4). Specifically, the controller operates: (d1) to rearrange the one or more scatter symbols based on a predetermined timing; (d2) to arrange the zero or more specific areas based on a predetermined timing; (d3) to replace the one or more scatter symbols which are rearranged in the one or more arrangement areas in which the zero or more specific areas are arranged, with zero or more wild scatter symbols indicating all scatter symbols; and (d4) to award a prize according to the number of the scatter symbols arranged in the one or more arrangement areas.

According to the above structure, in a display, one or more scatter symbols are rearranged in a matrix having one or more arrangement areas and zero or more specific areas are arranged in the one or more arrangement areas, based on a predetermined timing. The one or more scatter symbols rearranged in the one or more arrangement areas in which the zero or more specific areas are arranged are replaced with zero or more wild scatter symbols indicating all scatter symbols and a prize according to the number of the scatter symbols arranged in the one or more arrangement areas is awarded.

Accordingly, by seeing the arrangement of the zero or more specific areas and the rearrangement of the one or more scatter symbols in the one or more arrangement areas in which the zero or more specific areas are arranged, a player can expect a new prize resulting from the replacement of the one or more scatter symbols in the zero or more specific areas with the zero or more wild scatter symbols, so that a new entertainment characteristic can be provided.

A gaming machine of the invention includes: a display that has a matrix having one or more arrangement areas and arranges one or more scatter symbols and zero or more specific areas in the one or more arrangement areas; and a controller that is programmed to operate as described in the steps of (e1) to (e4). Specifically, the controller operates: (e1) to rearrange the one or more scatter symbols based on a predetermined timing; (e2) to arrange the zero or more specific areas based on a predetermined timing; (e3) to replace the one or more scatter symbols, which are rearranged in the one or more arrangement areas in which the zero or more specific areas are arranged, with one or more scatter symbols rearranged in the one or more adjacent arrangement areas, based on a predetermined condition; and (e4) to award a prize according to the number of the scatter symbols arranged in the one or more arrangement areas.

According to the above structure, in a display, one or more scatter symbols are rearranged in a matrix having one or more arrangement areas and zero or more specific areas are arranged in the one or more arrangement areas, based on a predetermined timing. The one or more scatter symbols rearranged in the one or more arrangement areas in which the zero or more specific areas are arranged, are replaced with one or more scatter symbols rearranged in the one or more adjacent arrangement areas and a prize according to the number of the scatter symbols arranged in the one or more arrangement areas is awarded.

Accordingly, by seeing the arrangement of the zero or more specific areas and the rearrangement of the one or more scatter symbols in the one or more arrangement areas in which the zero or more specific areas are arranged, a player can expect a new prize resulting from the replacement of the one or more scatter symbols in the zero or more specific areas with the one or more scatter symbols in the one or more adjacent arrangement areas, so that a new entertainment characteristic can be provided.

A playing method of the invention of a gaming machine in which one or more scatter symbols and zero or more specific areas are arranged in a matrix having one or more arrangement areas in a display includes the steps of: (f1) rearranging the one or more scatter symbols based on a predetermined timing; (f2) arranging the zero or more specific areas based on a predetermined timing; and (f3) awarding a prize according to the one or more scatter symbols, which are rearranged in the one or more arrangement areas in which the zero or more specific areas are arranged, and the number of the scatter symbols rearranged in the one or more arrangement areas.

According to the above structure, in a display, one or more scatter symbols are rearranged in a matrix having one or more arrangement areas and zero or more specific areas are arranged in the one or more arrangement areas, based on a predetermined timing. A prize according to the one or more scatter symbols, which are rearranged in the one or more arrangement areas in which the zero or more specific areas are arranged, and the number of the scatter symbols rearranged in the one or more arrangement areas is awarded.

Accordingly, by seeing the arrangement of the zero or more specific areas and the rearrangement of the one or more scatter symbols in the one or more arrangement areas in which the zero or more specific areas are arranged, a player can expect a prize based on the zero or more specific areas, separately from a prize resulting from the conventional arrangement of the one or more scatter symbols, so that a new entertainment characteristic can be provided.

### BRIEF DESCRIPTION OF THE DRAWINGS

FIG. 1 illustrates a playing method of a slot machine according to a first embodiment of the invention;

FIG. 2 is a block diagram of a slot machine;

FIG. 3 illustrates a display screen in a base game of a first embodiment;

FIG. 4 illustrates a display screen in a bonus game of a first embodiment;

FIG. 5 illustrates a display screen in a bonus game of a first embodiment;

FIG. 6 shows symbols and code numbers thereof;

FIG. 7 is a perspective view showing an external appearance of a slot machine;

FIG. 8 is a block diagram showing an electrical structure of an entire slot machine;

FIG. 9 is a block diagram showing an electrical structure of a sub-control board of a slot machine;

FIG. 10 is a flow chart of a game executing process that is performed in a slot machine;

FIG. 11 is a flow chart of a bonus game process that is performed in a slot machine;

FIG. 12 illustrates a playing method of a slot machine according to a second embodiment;

FIG. 13 illustrates a playing method of a slot machine according to a third embodiment; and

FIG. 14 illustrates a playing method of a slot machine according to a fourth embodiment.

### DESCRIPTION OF THE PREFERRED EMBODIMENTS

### First Embodiment

The following describes a first embodiment of a slot machine and a playing method according to the invention.

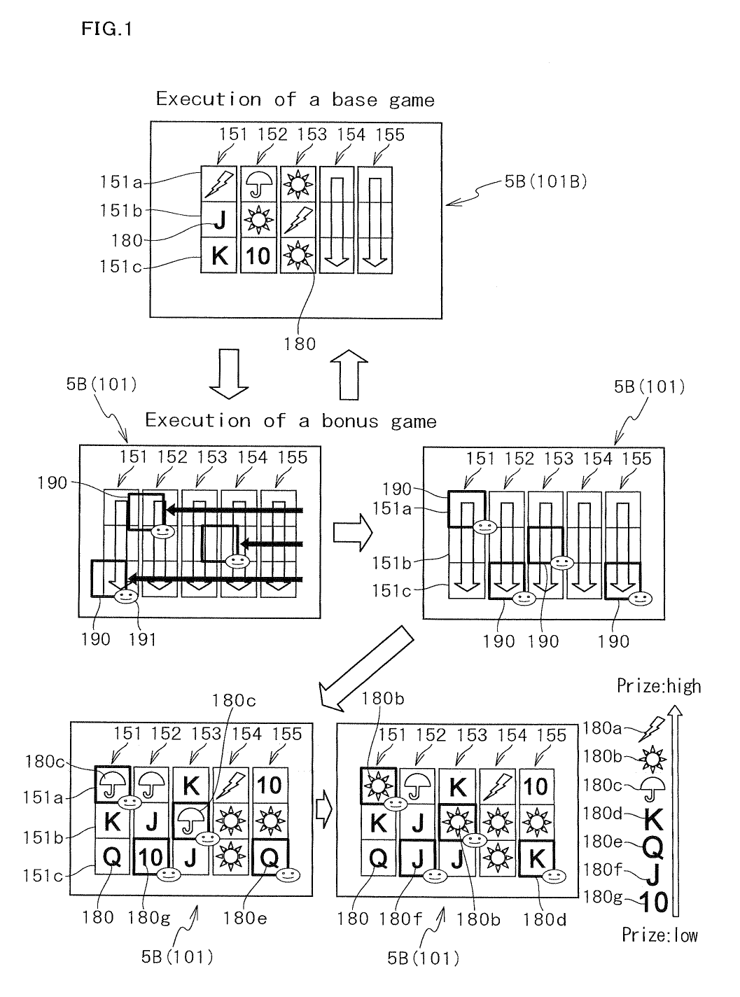

As shown in FIG. 1, a slot machine executes a playing method including the steps of: rearranging one or more scatter symbols 180 in display windows 151 to 155, based on a predetermined timing; arranging zero or more specific areas 190 in the one or more display windows 151 to 155 based on a predetermined timing; replacing the one or more scatter symbols 180, which are rearranged in the one or more display windows 151 to 155 in which the zero or more specific areas 190 are arranged, with one or more scatter symbols 180 indicating one or more prizes of predetermined magnitudes; and awarding a prize according to the number of the scatter symbols 180 arranged in the one or more display windows 151 to 155.

Herein, the “arrangement” means a state in which the scatter symbols 180 are visually recognizable of an exterior player. In other words, in FIG. 1, the scatter symbols 180 are under state of being displayed in the display windows 151 to 155 (having arrangement areas). In the mean time, the “rearrangement” means arranging the scatter symbols 180 again after dismissing the arrangement of the scatter symbols 180.

The scatter symbol is a symbol that allows an advantageous state to a player when the predetermined number of scatter symbols or more are displayed in the display windows 151 to 155 (having arrangement areas). The advantageous state is a state in which a coin is paid out in accordance with the scatter symbol, a state in which the payout-number of coins is added to the game media, a state in which a bonus game is started, and the like.

### (Display 101)

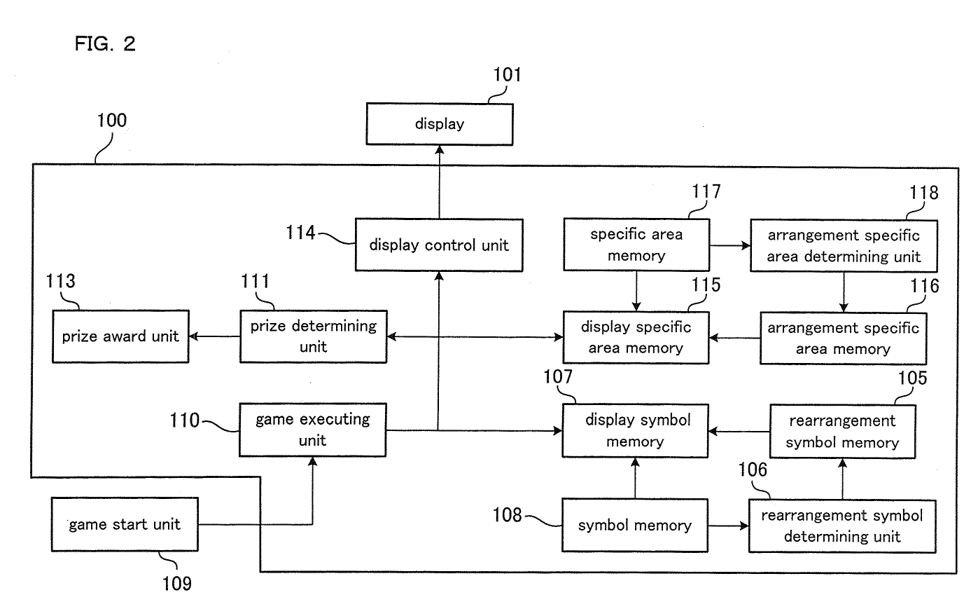

The slot machine that executes the playing method has, as shown in FIG. 2, a display 101 and a controller 100. The display 101 is configured to arrange the scatter symbols 180.

As shown in FIG. 1, the scatter symbols 180 include seven scatter symbols 180a to 180g that have prizes of different magnitudes, respectively. In other words, the scatter symbols 180 are symbols that indicate prizes of two or more different magnitudes respectively. To be more specific, the scatter symbol 180a is a scatter symbol that indicates “THUNDER” having the highest prize. The scatter symbol 180b is a scatter symbol that indicates “SUN” having the highest prize next to the scatter symbol 180a. The scatter symbol 180c is a scatter symbol that indicates “UMBRELLA” having the highest prize next to the scatter symbol 180b. The scatter symbol 180d is a scatter symbol that indicates “K” having the highest prize next to the scatter symbol 180c. The scatter symbol 180e is a scatter symbol that indicates “Q” having the highest prize next to the scatter symbol 180d. The scatter symbol 180f is a scatter symbol that indicates “J” having the highest prize next to the scatter symbol 180e. The scatter symbol 180g is a scatter symbol that indicates “10” having the highest prize next to the scatter symbol 180f.

Meanwhile, in this embodiment, the scatter symbols are the symbols having the prizes of seven different magnitudes, such as the scatter symbols 180a to 180g. However, the invention is not particularly limited, as long as two or more different magnitudes of prizes are indicated.

The display 101 may be a mechanical structure with a reel device for arranging the symbols 180 by rotation of a reel or electrical structure with a video reel on which an image is displayed for arranging the symbols 180. Further, the display 101 may be a structure of combining a mechanical structure (reel) and an electrical structure (video reel). The electrical structure may include a liquid crystal device, a CRT (cathode-ray tube), a plasma display and the like. In addition, the number of the display windows 151 to 155 (having arrangement areas) may be arbitrary. A detailed structure of the display 101 will be described later.

### (Controller 100)

The controller 100 is configured to execute a first process of rearranging the scatter symbols 180 in the display windows 151 to 155 based on a predetermined timing; a second process of arranging the specific areas 190 in the display windows 151 to 155, based on a predetermined timing; a third process of replacing the scatter symbols 180, which are rearranged in the display windows 151 to 155 in which the specific areas 190 are arranged, with the scatter symbols 180 indicating prizes of predetermined magnitudes; and a fourth process of awarding a prize according to the number of the scatter symbols 180 arranged in the display windows 151 to 155. In other words, the controller 100 has first to fourth processing units.

The controller 100 includes a symbol memory 108 for storing all scatter symbols 180 and a display symbol memory 107 for storing the scatter symbols 180 in the symbol memory 108 each as a display symbol. The display symbol memory 107 can be accessed by a display control unit 114. The display control unit 114 reads out the scatter symbols 180 in the display symbol memory 107 under control of a game executing unit 110 and displays the scatter symbols 180 in the display 101. A detailed display state will be described later.

Furthermore, the controller 100 includes a specific area memory 117 that stores all the specific areas 190 and a display specific area memory 115 that stores the specific areas 190 of the specific area memory 117 as specific areas for display. The display specific area memory 115 can be accessed by the display control unit 114. The display control unit 114 reads out the specific areas of the display specific area memory 115 and displays the specific areas 190 on the display 101, under control of the game executing unit 110. Detailed display aspects will be described later.

In addition, the controller 100 includes a rearrangement symbol determining unit 106 that determines symbols to be rearranged in every unit game, based on the scatter symbols 180 stored in the symbol memory 108. The symbols to be rearranged, which are determined by the rearrangement symbol determining unit 106, are stored in a rearrangement symbol memory 105, are outputted to the display symbol memory 107 and are then used for an image process in the display control unit 114, so that they are displayed in the display 101.

Further, the controller 100 includes an arrangement specific area determining unit 118 that determines specific areas to be arranged every unit game based on the specific areas 190 stored in the specific area memory 117. The specific areas to be arranged, which are determined by the arrangement specific area determining unit 118, are stored in the arrangement specific area memory 116, outputted to the display specific area memory 115 and then used for an image process in the display control unit 114, so that they are displayed on the display 101.

Furthermore, the controller 100 is associated with a game start unit 109. The game start unit 109 has a function of outputting a game start signal by an operation of the player. In addition, the controller 100 includes a game executing unit 110 that executes a unit game in which the scatter symbols 180 are rearranged and the specific areas 190 are arranged, a prize determining unit 111 that determines a prize in a unit game, and a prize award unit 113 that awards the prize determined in the prize determining unit 111.

The game executing unit 110 starts, based on a predetermined timing, a variable display of the scatter symbols 180 arranged in the display windows 151 to 155 with a game start signal, as trigger, from the game start unit 109 and rearranges the scatter symbols 180 at a timing at which a predetermined time has elapsed after the variable display is started, in the display 101. In other words, the controller 100 executes a first process of rearranging the scatter symbols 180 in the display windows 151 to 155, based on a predetermined timing.

Furthermore, the game executing unit 110 starts, based on a predetermined timing, a variable display of the specific areas 190 with a game start signal, as trigger, from the game start unit 109 and arranges the specific areas 190 at a timing at which a predetermined time has elapsed after the variable display is started, in the display 101. In other words, the controller 100 executes a second process of arranging the specific areas 190 in the display windows 151 to 155, based on a predetermined timing.

After the scatter symbols 180 are rearranged and the specific areas 190 are arranged in the display windows 151 to 155 through the first and second processes, the display control unit 114 replaces the scatter symbols 180, which are rearranged in the display windows 151 to 155 in which the specific areas 190 are arranged, with the scatter symbols 180 that indicate the prizes one larger than the prizes indicated by the rearranged scatter symbols 180. In other words, the controller 100 executes a third process of replacing the scatter symbols 180, which are rearranged in the display windows 151 to 155 in which the specific areas 190 are arranged, with the scatter symbols 180 indicating prizes of predetermined magnitudes.

The prize determining unit 111 determines a prize that is determined by the number of the scatter symbols 180 arranged in the display windows 151 to 155 in a unit game. The prize award unit 113 awards a prize based on the determination of the prize determining unit 111. In other words, the controller 100 executes a fourth process of awarding a prize according to the number of the symbols 180 arranged in the display windows 151 to 155.

In the mean time, the third and fourth processes are to replace the scatter symbols 180, which are rearranged in the arrangement areas in which the specific areas 190 are arranged, with the scatter symbols indicating prizes of predetermined magnitudes and to award a prize according to the number of the symbols 180 arranged in the display windows 151 to 155. In other words, it can be said that the controller 100 executes a process of awarding a prize according to the scatter symbols 180, which are rearranged in the display windows 151 to 155 in which the specific areas 190 are arranged, and the number of the scatter symbols 180 rearranged in the display windows 151 to 155.

In the mean time, each block of the controller 100 may be structured with a hardware or software, as required.

### (Operation of the Controller 100)

In the followings, an operation of the controller 100 will be described. First, the scatter symbols to be rearranged are determined by the rearrangement symbol determining unit 106 and the determined symbols to be rearranged are stored in the rearrangement symbol memory 105. The symbols to be rearranged, which the rearrangement symbol memory 105 stores, are stored in the display symbol memory 107. The symbols to be rearranged, which are stored in the display symbol memory 107, are enabled to be displayed in the display 101 by the display control unit 114. When a unit game is executed by the game executing unit 110, a variable display of the scatter symbols is started and the scatter symbols to be rearranged, which are stored in the display symbol memory 107, are displayed in the display 101 at a timing at which a predetermined time has elapsed from the start of the variable display, so that the scatter symbols 180 are rearranged in the display windows 151 to 155. Thereby, the controller 100 executes a first process of rearranging the scatter symbols 180 in the display windows 151 to 155 based on a predetermined timing.

In addition, the specific areas to be arranged are determined by the arrangement specific area determining unit 118 and the determined specific areas to be arranged are stored in the arrangement specific area memory 116. The specific areas to be arranged, which the arrangement specific areas memory 116 stores, are stored in the display specific area memory 115. The specific areas to be arranged, which are stored in the display specific area memory 115, are enabled to be displayed in the display 101 by the display control unit 114. When a unit game is executed by the game executing unit 110, a variable display of the specific areas 190 is started and the specific areas 190 to be rearranged, which are stored in the display specific area memory 115, are displayed in the display 101 at a timing at which a predetermined time has elapsed from the start of the variable display, so that the specific areas 190 are arranged in the display windows 151 to 155. Thereby, the controller 100 executes a second process of arranging the specific areas 190 in the display windows 151 to 155 based on a predetermined timing.

Then, the scatter symbols 180, which are rearranged in the display windows 151 to 155 in which the specific areas 190 are arranged, are replaced and then displayed with the scatter symbols 180, which indicate the prizes one larger, by the display control unit 114. Thereby, the controller 100 executes a third process of replacing the scatter symbols 180, which are rearranged in the display windows 151 to 155 in which the specific areas 190 are arranged, with the scatter symbols 180 indicating prizes of predetermined magnitudes.

Then, a win is determined by the number of the scatter symbols 180 rearranged and a prize based on the win is awarded by the prize determining unit 111 and the prize award unit 113. Thereby, the controller 100 executes a fourth process of awarding a prize according to the number of the scatter symbols 180 arranged in the display windows 151 to 155.

As clearly seen from the above operations, the slot machine 1 embodies a playing method including the steps of rearranging the scatter symbols 180 in the display windows 151 to 155 based on a predetermined timing, arranging the specific areas 190 in the display windows 151 to 155 based on a predetermined timing; replacing the scatter symbols 180, which are rearranged in the display windows 151 to 155 in which the specific areas 190 are arranged, with the scatter symbols 180 indicating prizes of predetermined magnitudes; and awarding a prize according to the number of the scatter symbols 180 arranged in the display windows 151 to 155.

According to the above playing method, in the display 101, the scatter symbols 180 indicating prizes of two or more different magnitudes are rearranged in the display windows 151 to 155 forming a matrix shape and the specific areas 190 are arranged in the display windows 151 to 155, based on a predetermined timing. The scatter symbols 180, which are rearranged in the display windows 151 to 155 in which the specific areas 190 are arranged, are replaced with the scatter symbols 180 indicating prizes of predetermined magnitudes and a prize according to the number of the scatter symbols 180 arranged in the display windows 151 to 155 is awarded.

Accordingly, by seeing the arrangement of the specific areas 190 and the rearrangement of the scatter symbols 180 in the display windows 151 to 155 in which the specific areas 190 are arranged, a player can expect a new prize resulting from the replacement of the scatter symbols 180 in the specific areas 190, so that a new entertainment characteristic can be provided.

### (Display State)

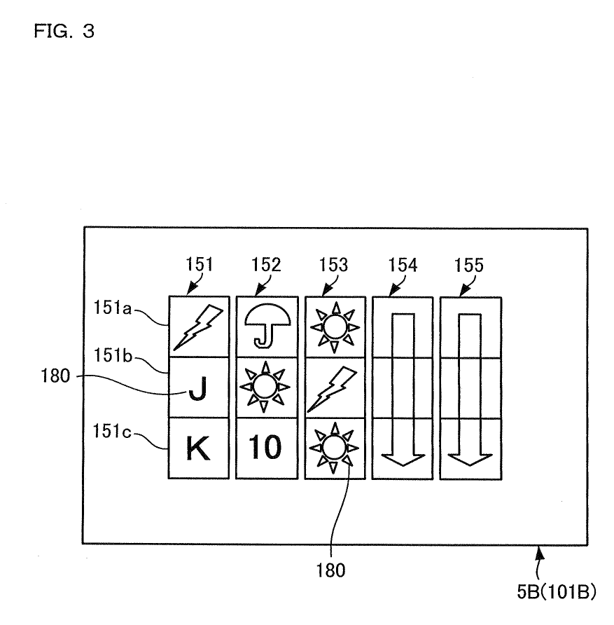

The following specifically describes an example of a display state of the display 101, with respect to the operation processes of the slot machine 1 and the playing method. In the mean time, as shown in FIG. 3, the display state is described with reference to a structure in which the display 101 arranges the symbols in a video reel manner.

The display 101 has display windows 151 to 155 (columns 151 to 155 each including arrangement areas) that arrange the scatter symbols 180. The display windows 151 to 155 are arranged in a center of the display 101. A symbol column consisting of the scatter symbols 180 is scrolled in the display windows 151 to 155 (see FIG. 3). In addition, the respective display windows 151 to 155 are divided into arrangement areas such as upper stage 151a, 152a, 153a, 154a, 155a, central stage 151b, 152b, 153b, 154b, 155b and lower stage 151c, 152c, 153c, 154c, 155c. The scatter symbols 180 are respectively stopped (arranged) in the respective stages 151a to 155a, 151b to 155b, and 151c to 155c. For example, in FIG. 3, “THUNDER” is stopped in 151a of the upper stage of the display window 151, “SUN” is stopped in 152b of the central stage of the display window 152 and “SUN” is stopped in 153c of the lower stage of the display window 153. Thereby, the display windows 151 to 155 display a symbol matrix consisting of 5 columns/3 rows. In the mean time, the symbol matrix is not limited to 5 columns/3 rows.

In addition, when the predetermined number of symbols referred to as scatter symbols 180 is displayed in the display 101, a process of awarding a prize such as coin is performed. To be more specific, as shown in FIG. 3, when four or more “SUN” of scatter symbol are rearranged (displayed) in the display windows 151 to 155 in the display 101, a coin is paid out.

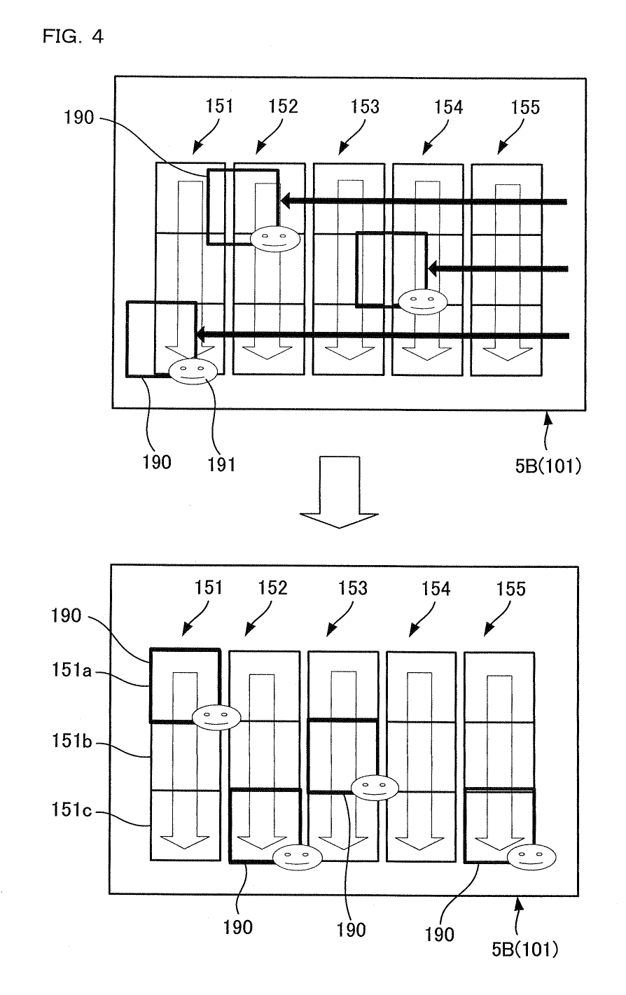

As shown in FIG. 4, when the display 101 scrolls the scatter symbols 180, it subsequently scrolls zero to fifteen specific areas 190 from the right to the left direction. Then, the display stops the scroll of the specific areas 190 and arranges the specific areas in the arrangement areas. To be more specific, as shown in FIG. 4, the display arranges the specific areas 190 in the arrangement areas 151a, 152c, 153b, and 155c.

As shown in FIG. 4, when the specific areas 190 are arranged in the display windows 151 to 155, a closing line is displayed so that a player can recognize the presence/absence of the arrangement of the specific areas. In addition, characters 191 relating to a game are displayed at the lower right part of the specific areas 190. Thereby, since a player can easily recognize the specific areas 190 through the characters 191, the player can clearly recognize that there is a determination relating to an award of a prize, separately from a determination of the scatter symbols and can expect a prize based on the specific areas. As a result, a new entertainment characteristic can be provided.

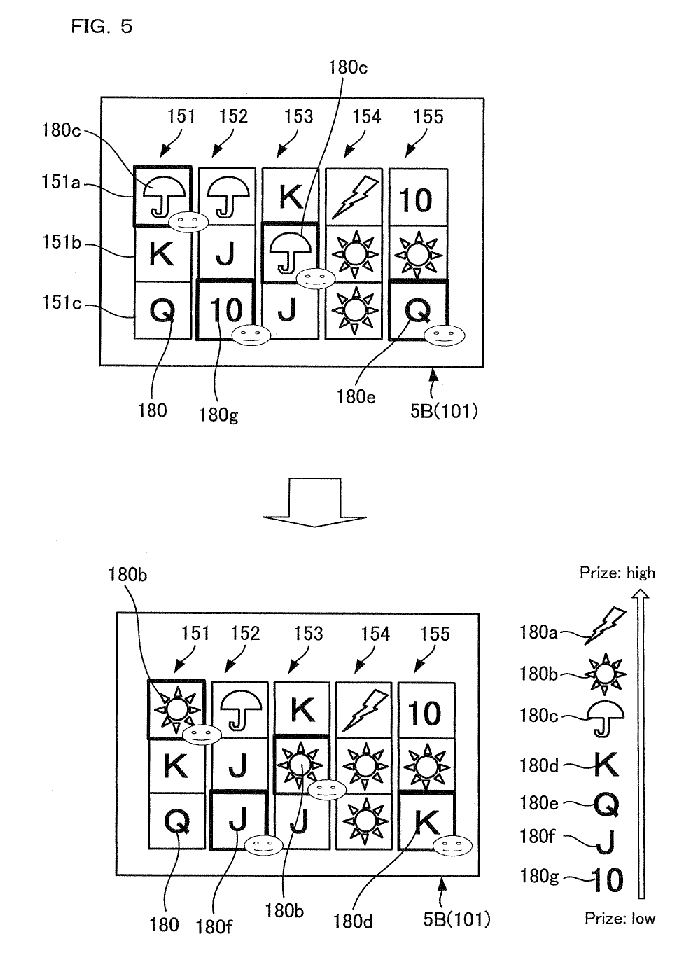

As shown in FIG. 5, when the specific areas 190 are arranged in the display windows 151 to 155, the scroll of the scatter symbols 180 is stopped and the scatter symbols 180 are rearranged in the display windows 151 to 155. Then, the scatter symbols 180, which are rearranged in the arrangement areas 151a, 152c, 153b, 155c in which the specific areas 190 are arranged, are replaced with the scatter symbols 180 that indicate the prizes one larger. To be more specific, the scatter symbol 180c rearranged in the arrangement area 151a is replaced with the scatter symbol 180b that indicates the prize one larger. Likewise, the scatter symbol 180g rearranged in the arrangement area 152c is replaced with the scatter symbol 180f. Likewise, the scatter symbol 180c rearranged in the arrangement area 153b is replaced with the scatter symbol 180b. Likewise, the scatter symbol 180e rearranged in the arrangement area 155c is replaced with the scatter symbol 180d.

Then, a prize according to the number of the replaced scatter symbols 180 is awarded. To be more specific, as shown in FIG. 5, a prize awarded is based on the number of the scatter symbols, such as one scatter symbol 180a, five scatter symbols 180b, one scatter symbol 180c, three scatter symbols 180d, one scatter symbol 180e, three scatter symbol 180f and one scatter symbol 180g.

In the mean time, in this embodiment, the number of specific areas 190 falls within a range of zero to fifteen, inclusive. However, the number of specific areas provided is not limited to the range of zero to fifteen as long as the number of the specific areas is at least zero and not more than the number of the arrangement areas. In other words, the specific areas 190 may not be provided or may be arranged in all the display windows 151 to 155.

In addition, in this embodiment, the specific area is a closing line that allows a player to recognize the presence/absence of the arrangement of the specific area. However, the invention is not particularly limited thereto. For example, the specific area may be an identifier that allows a player to recognize the presence/absence of the arrangement of the specific area.

In addition, in this embodiment, the character 191 relating to a game is displayed in the lower right part of the specific area. However, the invention is not particularly limited thereto. For example, the character 191 may be displayed in any position of the specific area, such as center, edge, upper, right, left or lower part.

In addition, in this embodiment, the specific area 190 is scrolled to the left direction from the right direction. However, the invention is not particularly limited thereto. For example, the specific area may be scrolled in a direction perpendicular to the scroll direction of the scatter symbols 190, from the left to the right direction, from the upper left to the lower right direction, from the lower left to the upper right direction, from the upper right to the lower left direction, from the lower right to the upper left direction, or in a direction opposite to the scroll direction of the scatter symbols 180. Thereby, since a player can easily recognize the arrangement of the specific areas, the player can clearly recognize that a determination relating to the award of prize is separated from a determination of a scatter symbol. In addition, since the player can expect a prize based on the specific areas, a new entertainment characteristic can be provided.

In addition, in this embodiment, during the rearrangement of the scatter symbols 180, the specific areas 190 are arranged and the rearrangement of the scatter symbols is then completed. However, the invention is not particularly limited thereto. For example, the initiation and completion of the rearrangement of the scatter symbols and the initiation and completion of the arrangement of the specific areas may be done at any timings and the order of the operations may be arbitrary, which still exhibit the effects of the invention.

### (Symbol, Combination and the Like)

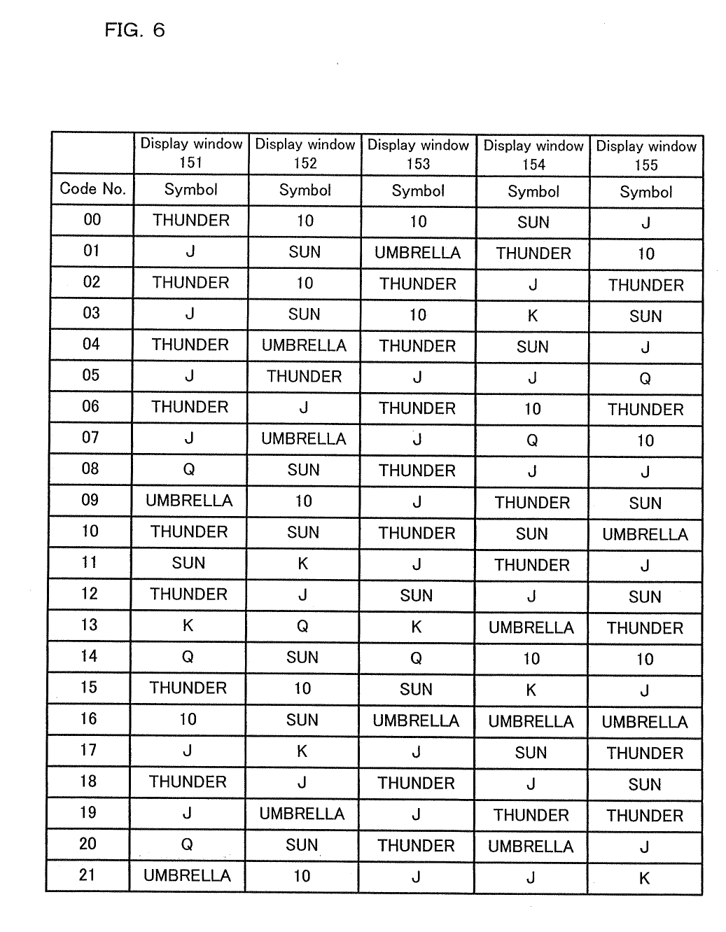

As shown in FIG. 6, the scatter symbols 180 to be displayed in the display windows 151 to 155 of the display 101 constitute the symbol columns by 22 symbols. The symbols constituting the respective symbol columns are given with one code number of zero to twenty-one. Each of the symbol columns is constituted with a combination of symbols of “THUNDER,” “J,” “Q,” “UMBRELLA,” “SUN,” “K” and “10.”

The three successive symbols in the symbol columns are displayed (arranged) in the arrangement areas of upper stage 151a, 152a, 153a, 154a, 155a, the center stage 151b, 152b, 153b, 154b, 155b and the lower stage 151c, 152c, 153c, 154c, 155c, respectively, so that they constitute a symbol matrix of 5 columns/3 rows in the display windows 151 to 155. When a BET button is pushed and then a start button is pushed to start a game, the symbol columns constituting the symbol matrix are scrolled. When a predetermined time period has elapsed after the scroll has started, each scroll of the symbols is stopped (rearranged).

In addition, for each symbol, a predetermined scatter symbol is determined in advance. A scatter symbol is a symbol that allows an advantageous state to a player when the predetermined number of scatter symbols is displayed in the display windows 151 to 155. The advantageous state is a state in which a coin is paid out in accordance with the scatter symbol, a state in which the payout-number of coins is added to the game media, a state in which a bonus game is started, and the like.

To be more specific, when three or more symbols of “SUN” are rearranged in the display window 151 to 155, a bonus is triggered and a gaming state is shifted to a bonus game from a base game. In addition, when four or more symbols of “SUN” are displayed in the display windows 151 to 155, twenty coins (game medium) are paid out per one bet.

In the mean time, the bonus game is a gaming state that is more advantageous than a base game. In one embodiment, the bonus game is a free game. The free game is a gaming state allowing a player to play a game for a predetermined number of times, without betting a coin. The bonus game is not particularly limited as long as it is a gaming state advantageous to the player; i.e., it is more advantageous than the base game. For example, the bonus game may include a state in which it is possible to obtain more game media than the base game, a state in which it is possible to obtain a game medium in a higher probability than in the base game, a state in which a game medium is less consumed than in the base game, and the like. Specifically, a free game, a second game, a feature game and the like are examples of the bonus game.

### (Mechanical Structure of the Slot Machine 1)

The following descries an example of the slot machine 1 structured in a mechanical and electrical manner.

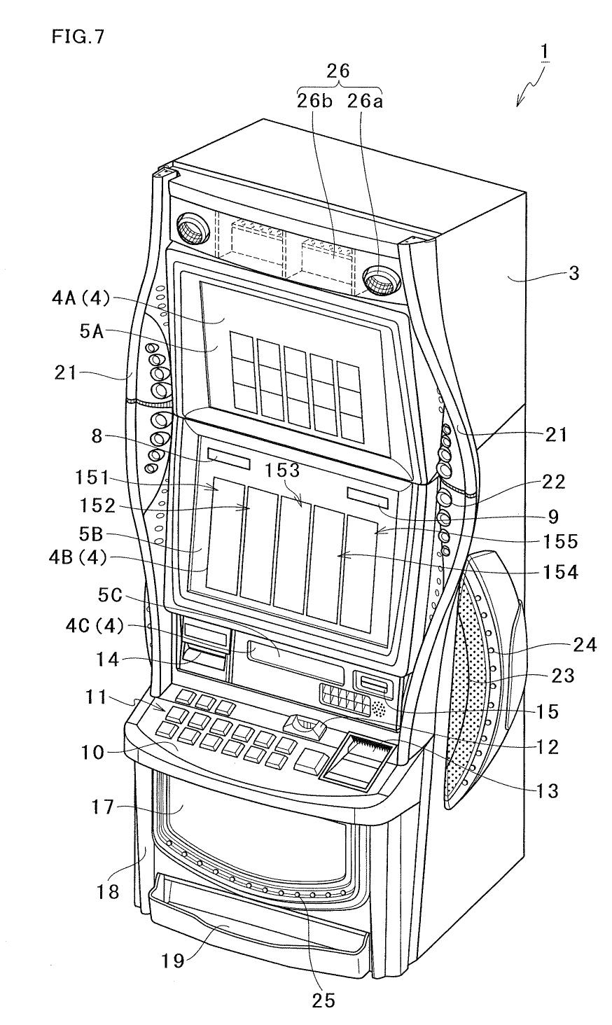

As shown in FIG. 7, the slot machine 1 is an upright-type slot machine provided in a game arcade such as casino and the like and has a cabinet 3 for receiving electrical or mechanical parts so as to execute a game aspect. As a display unit 4 for displaying the game information based on a game operation of a player, there are an upper variable display unit 4A, a central variable display unit 4B and a lower variable display unit 4C, for example. Each of the display units 4A, 4B, and 4C is attached to a front of the rectangular-parallelepiped shaped cabinet 3.

The upper variable display unit 4A is a display unit on which a player watches during the unit game and has a transparent upper liquid crystal panel 5A that is fixed onto a front door of the cabinet 3. A variety of effect images are displayed in the upper liquid crystal panel 5A during the unit game. For example, an effect of a moving picture is performed in the upper liquid crystal panel 5A when a winning is made.

The central variable display unit 4B is a rotating symbol display panel on which a player always fixes the eyes and has a transparent central liquid crystal panel 5B that is fixed to the front door of the cabinet 3. The central liquid crystal panel 5B is provided with five display windows 151 to 155. Moreover, a payout-number display unit 8 and a credit-number display unit 9 are displayed in an upper part of the central liquid crystal panel 5B.

The lower variable display unit 4C has a lower liquid crystal panel 5C that displays a score recorded on a card or the score of a game. A numerical value displayed in the lower liquid crystal panel 5C is based on a display result of the central variable display unit 4B. When a winning combination is made in the central variable display unit 4B, a score of a game displayed in the lower liquid crystal panel 5C is added onto the basis of the winning combination made. A ticket printer 14 is provided to a left side of the lower liquid crystal panel 5C and a card reader 15 is provided to a right side of the lower liquid crystal panel 5C.

An operating table 10 that protrudes forward from the front face of the cabinet 3 is disposed below the lower variable display unit 4C. On the operating table 10, there are arranged operating buttons 11 (for example, bet button, collect button, start button 11a and the like) as an operating unit enabling a player to operate a game. In addition, a coin insertion slot 12 and a bill insertion slot 13 are provided to the operating table.

A waist-position panel 17 is disposed below the operating table 10. The waist-position panel 17 is a plastic panel having a game-related image printed thereto. The waist-position panel 17 is fixed onto a lower front door 18 and illuminated by a cold cathode-ray tube. In addition, a coin receiving portion 19 that collects coins which are paid out on the basis of a game result is disposed below the waist-position panel 17.

Furthermore, a light-emitting unit 20 is provided to the cabinet 3 of the slot machine 1 so that it surrounds a game area including the upper variable display unit 4A, the central variable display unit 4B, the lower variable display unit 4C and the operating table 10. The light-emitting unit 20 includes side lamps 22 that are provided to inclined parts 21, which are protruded in a bow shape at front right and left ends of the cabinet 3 and at side parts over the upper variable display unit 4A, the central variable display unit 4B and the lower variable display unit 4C, speaker lamps 24 that are provided to arc-shaped speaker 23, which are sideways protruded at the right and left ends of the cabinet 3 adjacent to the operating table 10, and are arranged along edges of the speakers 23, under lamps 25 that are provided to a lower front door 18 and arranged along lower edges of the waist-position panel 17, and top lamps 26 that are provided to an upper part of the upper variable display unit 4A and have power lamps 26a disposed at both sides and central band-shaped lamps 26b arranged in a horizontal direction.

### (Electrical Structure of the Slot Machine 1)

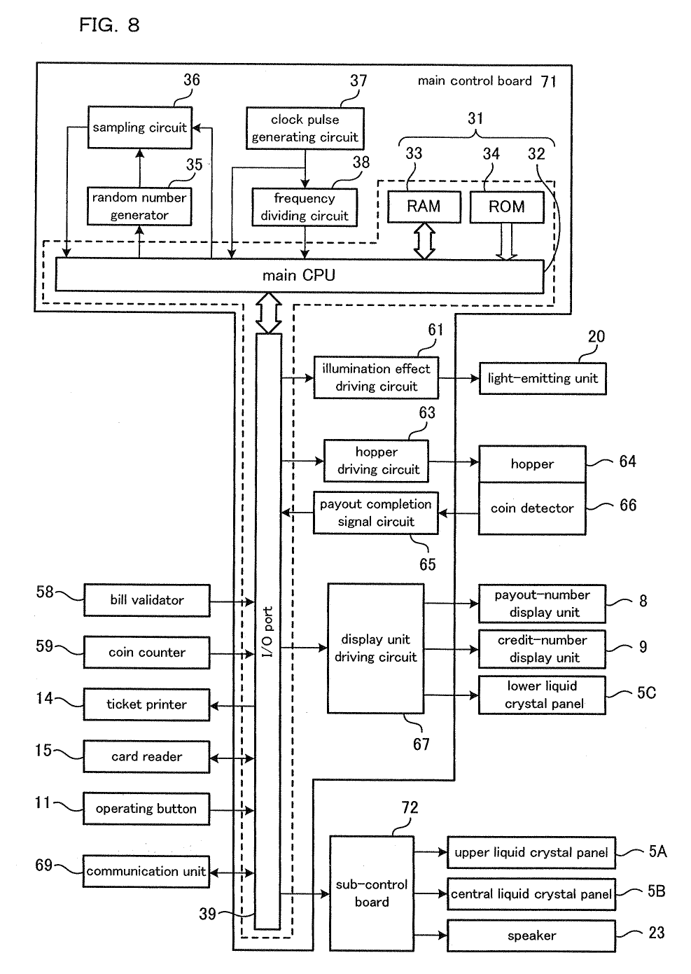

FIG. 8 is a block diagram showing an entire electrical structure of the slot machine 1. As shown in FIG. 8, the slot machine 1 has many components about a main control board 71 which includes a microcomputer 31. The main control board 71 has a microcomputer 31, a random number generator 35, a sampling circuit 36, a clock pulse generating circuit 37, a frequency dividing circuit 38, an illumination effect driving circuit 61, a hopper driving circuit 63, a payout completion signal circuit 65 and a display unit driving circuit 67.

The microcomputer 31 has a main CPU 32, a RAM 33 and a ROM 34. The main CPU 32 operates in accordance with a program stored in the ROM 34 and executes an input/output of a signal to and from the other components through an I/O port 39, thereby controls an overall operation of the slot machine 1. The RAM 33 stores data or a stop symbol determining program used when the main CPU 32 operates. For example, a random number value that is sampled by the sampling circuit 36 is temporarily maintained in the RAM after a game starts. In addition, the code numbers of the reels R1, R2, R3 are stored in the RAM. The ROM 34 stores a program that is executed by the main CPU 32, and permanent data.

The random number generator 35 is operated in accordance with an instruction of the main CPU 32 and generates a random number within a predetermined range. The sampling circuit 36 samples any of the random numbers that are generated by the random number generator 35 in accordance with an instruction of the main CPU 32 and inputs the sampled random number into the main CPU 32. The clock pulse generating circuit 37 generates a reference clock for operating the main CPU 32 and the frequency dividing circuit 38 inputs a signal that the reference clock is divided by a predetermined period to the main CPU 32.

Moreover, the main control board 71 is associated with the operating buttons 11 including a start button for inputting an instruction to stop the scroll of the symbol columns, a collect button, a bet button and the like and allows signals corresponding to the push of the buttons to be inputted into the main CPU 32 via the I/O port 39.

In addition, the main control board 71 is associated with a bill validator 58, a coin counter 59, a ticket printer 14, a card reader 15 and a communication unit 69.

The bill validator 58 reads an image of a bill inserted into the bill insertion slot 13 and receives the genuine bill in the cabinet 3. In addition, when receiving a genuine bill, the bill validator 58 outputs an input signal to the main CPU 32 based on an amount of the bill. The main CPU 32 stores a credit-number in the RAM 33, which corresponds to the amount of bill transmitted by the input signal.

The coin counter 59 is provided in the coin insertion slot 12 and identifies whether the coin inserted into the coin insertion slot 12 by the player is genuine or not. The bogus coin is discharged to the coin receiving portion 19. In addition, the coin counter 59 outputs an input signal to the main CPU 32 when it detects a genuine coin.

The ticket printer 14 prints a barcode on a ticket, in which data such as credit-number stored in the RAM 33, the date and time, the identification number of the slot machine 1 and the like is coded, based on the control signal outputted from the main CPU 32, and then outputs a ticket having the barcode attached thereto.

The card reader 15 reads the data from a smart card to transmit it to the main CPU 32, or writes the data on the smart card based on a control signal from the main CPU 32.

The communication unit 69 is provided to communicate with a host computer and the like equipped in the game arcade, through the network (communication line).

The illumination effect driving circuit 61 outputs an effect signal that makes the light-emitting unit 20 execute an illumination effect. The light-emitting unit 20 consists of many lamps or LED including the side lamps 22, the speaker lamps 24, the under lamps 25 and the top lamps 26.

The hopper driving circuit 63 drives a hopper 64 under control of the main CPU 32. The hopper 64 executes an operation of paying out a coin and pays out the coin to the coin receiving portion 19. The payout completion signal circuit 65 inputs data of the number of coins from a coin detection unit 66 associated thereto and inputs a signal to the main CPU 32 which notifies payout completion of the coin when the number of coins reaches a predetermined number. The coin detection unit 66 measures the number of coins paid out by the hopper 64 and inputs the data of the measured number to the payout completion signal circuit 65. The display unit driving circuit 67 controls the display operations of various display units such as the lower liquid crystal panel 5C.

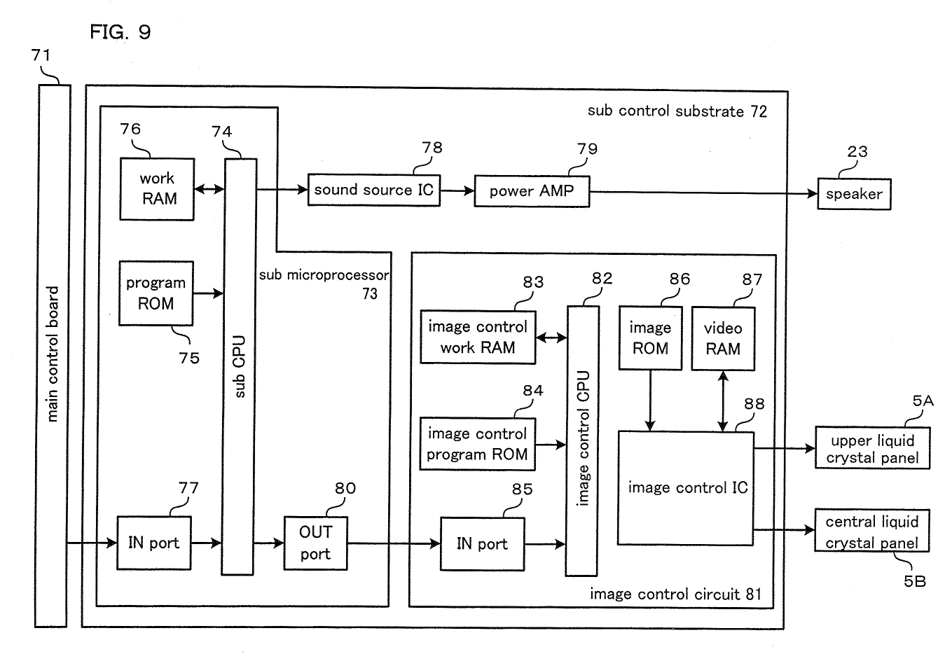

Further, the main control board 71 is associated with a sub control board 72. As shown in FIG. 9, the sub control board 72 performs a display control of the upper liquid crystal panel 5A of the upper variable display unit 4A, a display control of the central liquid crystal panel 5B of the central variable display unit 4B and an output control of sound by the speaker, based on commands inputted by the main control board 71. The sub control board 72 is included on a circuit board different from the circuit board constituting the main control board 71 and has a microcomputer 73 (hereinafter, referred to as “sub microcomputer”) as a main component. In addition, the sub control board has a sound source IC 78 controlling the sound outputted from the speaker 23, a power AMP 79 serving as an amplifier and an image control circuit 81 serving as a display control means of the upper liquid crystal panel 5A and the central liquid crystal panel 5B.

The sub microcomputer 73 has a sub CPU 74 that performs a control operation in accordance with a control command transmitted from the main control board 71, a program ROM 75 serving as a memory means, a work RAM 76, an IN port 77 and an OUT port 80. Although the sub control board 72 does not have a clock pulse generating circuit, a frequency dividing circuit, a random number generator and a sampling circuit, it is structured to execute a random number sampling on the operating program of the sub CPU 74. The program ROM 75 stores a control program that is executed in the sub CPU 74. The work RAM 76 is structured to serve as a temporary memory means when the control program is executed in the sub CPU 74.

The image control circuit 81 has an image control CPU 82, an image control work RAM 83, an image control program ROM 84, an IN port 85, an image ROM 86, a video RAM 87 and an image control IC 88. The image control CPU 82 determines an image that is displayed in the upper liquid crystal panel 5A and the central liquid crystal panel 5B, in accordance with the image control program stored in the image control program ROM 84, based on a parameter that is set in the sub microcomputer 73.

The image control program ROM 84 stores an image control program that is related to a display in the upper liquid crystal panel 5A and the central liquid crystal panel 5B, and various selection tables. The image control work RAM 83 is configured to serve as a temporary memory means when the image control program is executed in the image control CPU 82. The image control IC 88 forms an image corresponding to the content determined in the image control CPU 82 and outputs it to the upper liquid crystal panel 5A and the central liquid crystal panel 5B.

The image ROM 86 stores dot data for forming an image. The video RAM 87 serves as a temporary memory means when an image is formed in the image control IC 88.

### (Operation of the Slot Machine 1: Main Control Board 71)

In the followings, a process that is performed in the slot machine 1 will be described. As the main CPU 32 reads out and executes a game program, a game is progressed.

### (Game Executing Process)

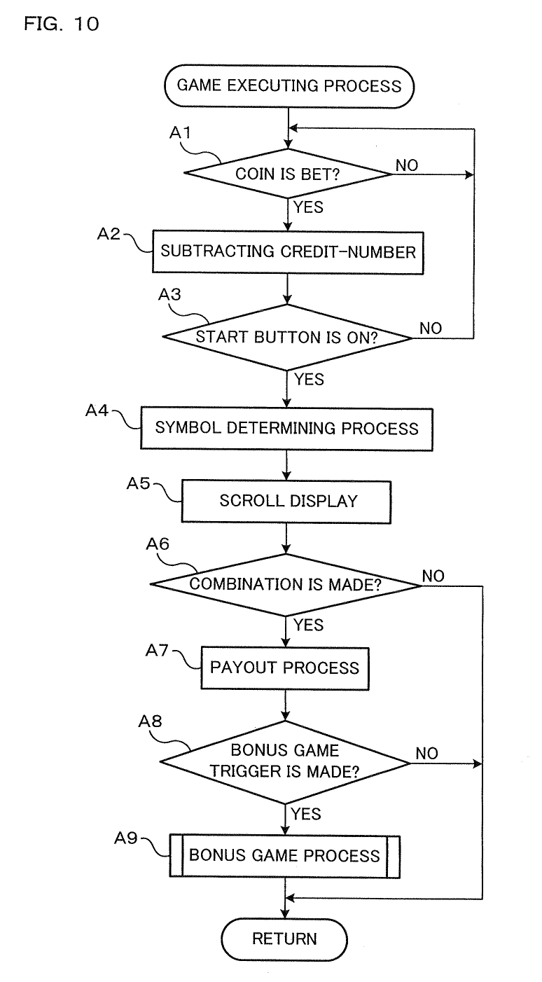

The main CPU 32 of the slot machine 1 carries out a game executing process routine shown in FIG. 10. When the game executing process routine is carried out, the main CPU 32 determines whether a coin is bet or not (A1). In this process, it is determined whether an input signal due to a push of the bet button is received or not. When it is determined that a coin is not bet (A1, NO), step A1 is re-executed, so that the CPU waits until a coin is bet.

In the mean time, when it is determined that a coin is bet (A1, YES), the credit score stored in the RAM 33 is subtracted in accordance with the number of coins (A2). Meanwhile, when the number of coins bet is greater than the credit score stored in the RAM 33, step A2 is re-executed without subtracting the credit score. In addition, when the number of coins bet exceeds the upper limit (in this embodiment, 50 pieces) allowed for a player to bet in a single game, step A3 is executed without subtracting the credit score.

Next, it is determined whether a start button is ON or not (A3). When it is determined that the start button is not ON (A3, NO), the process is returned to step A1. Meanwhile, when it is determined that the start button is not ON (for example, the start button is not ON and an instruction to end the game is inputted), the subtraction result in step A2 is cancelled.

In the mean time, when it is determined that the start button is ON (A3, YES), a symbol determining process is executed (A4). In other words, a stop symbol determining program stored in the RAM 33 is executed, so that it determines a symbol matrix including the fifteen symbols 180 to be stopped.

Then, the symbols 180 of the display windows 151 to 155 are scrolled (A5). After the scroll of the symbols 180 is started and then a predetermined time (base time) has elapsed, the symbol matrix determined in step A4 is stopped (rearranged) in the display windows 151 to 155.

Then, it is determined whether a combination is made or not, i.e., whether a prize is awarded based on the number of the scatter symbols 180 stopped in the display windows 151 to 155 (A6). When it is determined that a prize is not awarded (A6, NO), this routine is ended. In the mean time, when it is determined that a prize is awarded (A6, YES), a payout process is executed (A7). In other words, the number of payout coins based on the award of prize made is calculated. When the coins to be paid out are stored, a predetermined number of credits is added to the credit score stored in the RAM 33. In the mean time, when the coins are paid out, a control signal is transmitted to the hopper 64, so that a predetermined number of coins are paid out through the coin receiving portion 19.

Then, it is determined whether a bonus trigger is made (A8). In other words, it is determined whether three or more “SUNs” are arranged in the display windows 151 to 155. When it is determined that a bonus trigger is not made (A8, NO), this routine is ended. In the mean time, when it is determined that a bonus trigger is made (A8, YES), a bonus game process is executed (A9). The bonus game process will be described later. Then, this routine is ended.

### (Bonus Game Process)

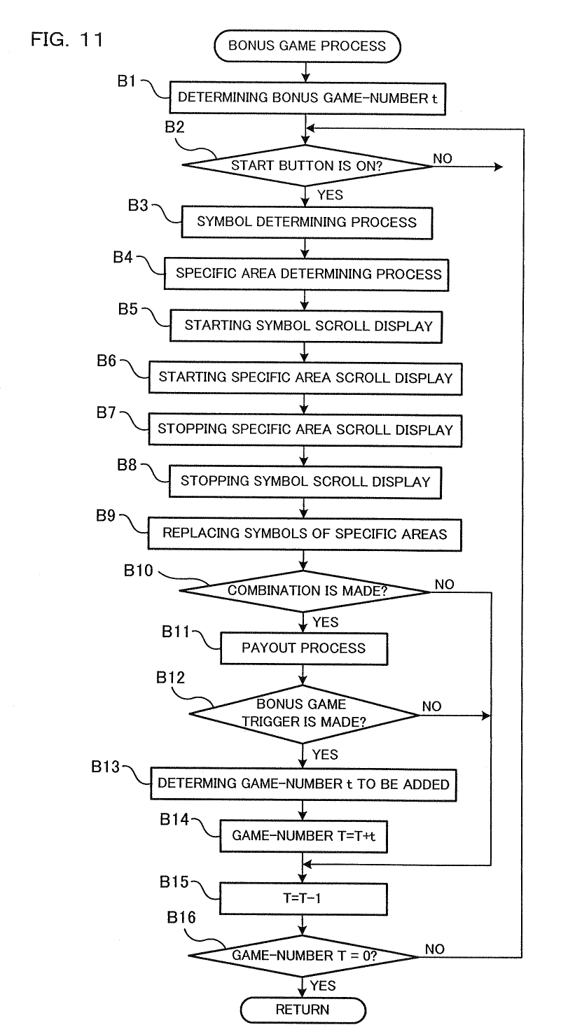

The main CPU 32 of the slot machine 1 executes a bonus game process routine shown in FIG. 11, in step A9 when it is determined in step A8 in FIG. 10 that a bonus trigger is made. When a bonus game process routine is executed, the bonus game-number T is determined by the main CPU 32 (B1). Then, it is determined whether a start button is ON (B2). When it is determined that a start button is not ON (B2, NO), the process is returned to step B2.

Then, a symbol determining process is executed (B3). In other words, a stop symbol determining program stored in the RAM 33 is executed, so that a symbol matrix including fifteen symbols 180 to be stopped is determined.

Then, a specific area determining process is executed (B4). In other words, a specific area determining program stored in the RAM 33 is executed, so that the number of the specific areas to be stopped which falls within a range of zero to fifteen, and the arrangement positions thereof on the display windows 151 to 155 are determined.

Then, the scatter symbols 180 are scrolled in the display windows 151 to 155 (B5).

Then, as shown in FIG. 4, the specific areas 190 are scrolled from the right to the left direction (B6). After the scroll of the specific areas 190 is started and then a predetermined time period (base time) has elapsed, the specific areas are stopped (arranged) at the arrangement positions on the display windows 151 to 155, which are determined in step B4 (B7).

After the scroll of the scatter symbols 180 is started and then a predetermined time (base time) has elapsed, the symbol matrix determined in step B3 is stopped (rearranged) in the display windows 151 to 155 (B8).

Then, a symbol replacing process of the specific areas is executed (B9). To be more specific, the scatter symbols 180 rearranged in the display windows 151 to 155 in which the specific areas 190 are arranged are replaced and displayed with the scatter symbols 180 that indicate the prizes one larger.

Then, it is determined whether a combination is made or not, i.e., whether a prize is awarded based on the number of the scatter symbols 180 stopped in the display windows 151 to 155 (B10). When it is determined that a prize is not awarded (B10, NO), the process proceeds to step B15. In the mean time, when it is determined that a prize is awarded (B10, YES), a payout process is executed (B11). In other words, the number of payout coins is calculated based on the number of the scatter symbols 180. When the coins to be paid out are stored, a predetermined number of credits is added to the credit score stored in the RAM 33. In the mean time, when the coins are paid out, a control signal is transmitted to the hopper 64, so that a predetermined number of coins are paid out through the coin receiving portion 19.

Then, it is determined whether a bonus trigger is made (B12). In other words, it is determined whether three or more “SUNs” are arranged in the display windows 151 to 155. When it is determined that a bonus trigger is made (B12, YES), a game-number t to be added is determined (B13). Then, the game-number t is added to the bonus game-number T (B14).

In the mean time, when it is determined in step B12 that a bonus trigger is not made (B12, NO), or after step B14, “one” is subtracted from the bonus game-number T(B15).

Then, it is determined whether or not the bonus game-number T is “zero” (B16). When it is determined that the bonus game-number T is not “zero” (B16, NO), the process is returned to step B2. In the mean time, when it is determined that the bonus game-number T is “zero” (B16, YES), this sub-routine is ended.

Like this, scatter symbols indicating prizes of two or more different magnitudes are rearranged in a matrix having arrangement areas in a display, and specific areas are arranged in the arrangement areas, based on a predetermined timing. The scatter symbols rearranged in the arrangement areas in which the specific areas are arranged are replaced with scatter symbols indicating prizes of predetermined magnitudes and a prize according to the number of the scatter symbols arranged in the arrangement areas is awarded.

Accordingly, by seeing the arrangement of the specific areas and the rearrangement of the scatter symbols in the arrangement areas in which the specific areas are arranged, a player can expect a new prize resulting from the replacement of the scatter symbols in the specific areas, so that a new entertainment characteristic can be provided.

### (Process Operation of the Slot Machine 1: Sub Control Board 72)

When the various processes are performed by the game executing process routine in the main control board 71, a result or content corresponding to the process is inputted as a command or data to the sub control board 72. The sub control board 72 performs the display of the payout-number display unit 8, credit-number display unit 9 and the like of the central liquid crystal panel 5B, display unit and displays an effect image in the upper liquid crystal panel 5A. In addition, the sub control board 72 performs an effect relating to an output of the sound from the speaker 23, in combination with, or independently of the effect in the upper liquid crystal panel 5A.

### Second Embodiment

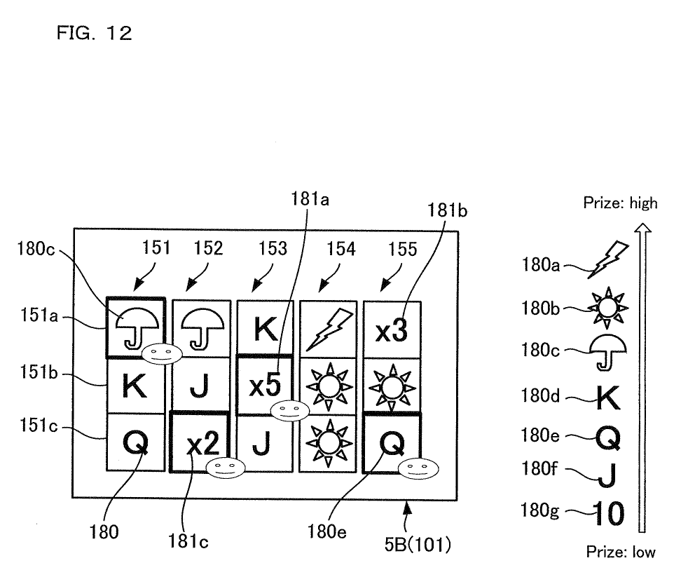

A second embodiment of the slot machine and the playing method thereof according to the invention will be described with reference to FIG. 12. In the mean time, the members same as in the first embodiment are indicated with the same reference numerals.

As shown in FIG. 12, the slot machine executes a playing method including the steps of: rearranging one or more scatter symbols 180 and zero or more rate symbols 181 each of which indicating a prize rate in one or more display windows 151 to 155 based on a predetermined timing; arranging zero or more specific areas 190 in the one or more display windows 151 to 155 based on a predetermined timing; and awarding a prize according to prize rates, which are indicated by the zero or more rate symbols 181 rearranged in the one or more display windows 151 to 155 in which the zero or more specific areas 190 are arranged, and the number of the scatter symbols 180 rearranged in the one or more display windows 151 to 155.

Here, the “rate symbol” means a symbol that indicates a rate of a prize to be awarded, for example five times, three times, two times and the like.

### (Display 101)

The slot machine, which executes the above playing method, has a display 101 and a controller 100 like the first embodiment. The display 101 is configured to arrange the scatter symbols 180 and the rate symbols 181.

As shown in FIG. 12, the rate symbols 181 include a rate symbol 181a that indicates a rate of five times, a rate symbol 181b that indicates a rate of three times and a rate symbol 181c that indicates a rate of two times. The rate symbols 181a to 181c are scrolled in the display windows 151 to 155 like the scatter symbols 180. A detailed structure of the display 101 will be described later.

### (Controller 100)

The controller 100 is structured to execute a fifth process of rearranging the scatter symbols 180 and the rate symbols 181 each of which indicating a prize rate in the display windows 151 to 155, based on a predetermined timing; a second process of arranging the specific areas 190 in the display windows 151 to 155 based on a predetermined timing; and a sixth process of awarding a prize according to prize rates which are indicated by the rate symbols 181 rearranged in the display windows 151 to 155 in which the specific areas 190 are arranged, and the number of the scatter symbols 180 rearranged in the display windows 151 to 155. In other words, the controller 100 has a fifth processing unit, a second processing unit and a sixth processing unit.

The controller 100 includes a symbol memory 108 for storing all the scatter symbols 180 and all the rate symbols 181, and a display symbol memory 107 for storing the scatter symbols 180 and the rate symbols 181 in the symbol memory 108 as scatter symbols for display and rate symbols for display. The display control unit 114 reads out the scatter symbols 180 and the rate symbols 181 in the display symbol memory 107 under control of a game executing unit 110, and displays the scatter symbols 180 and the rate symbols 181 in the display 101. A detailed display state will be described later.

In addition, as same as the first embodiment, the controller 100 has a rearrangement symbol determining unit 106 that determines the scatter symbols 180 and the rate symbols 181 to be rearranged in every unit game, based on the scatter symbols 180 and the rate symbols 181 stored in the symbol memory 108. The scatter symbols 180 and the rate symbols 181 to be rearranged, which are determined by the rearrangement symbol determining unit 106, are stored in the rearrangement symbol memory 105, outputted to the display symbol memory 107 and then used for an image process in the display control unit 114, so that they are displayed in the display 101.

The game executing unit 110 starts a variable display of the scatter symbols 180 and the rate symbols 181 arranged in the display windows 151 to 155 with a game start signal from the game start unit 109 as trigger based on a predetermined timing, and rearranges the scatter symbols 180 and the rate symbols 181 in the display 101 at a timing at which a predetermined time has elapsed after the variable display is started. In other words, the controller 100 executes a fifth process of rearranging the scatter symbols 180 and the rate symbols 181 each of which indicating prize rates in the display windows 151 to 155, based on a predetermined timing.

As described in the first embodiment, controller 100 executes a second process of arranging the specific areas 190 in the display windows 151 to 155, based on a predetermined timing.

In a unit game, the prize determining unit 111 determines a prize that is determined by the prize rates which are indicated by the rate symbols rearranged in the display windows 151 to 155 in which the specific areas 190 are arranged, and the number of the scatter symbols 180 arranged in the display windows 151 to 155. Then, the prize award unit 113 awards a prize based on the determination of the prize determining unit 111. In other words, the controller 100 executes a sixth process of awarding a prize according to prize rates which are indicated by the rate symbols rearranged in the arrangement areas in which the specific areas are arranged, and the number of the scatter symbols rearranged in the arrangement areas.

In the mean time, each block of the controller 100 may be structured with hardware or software, as required.

In addition, in this embodiment, there are three rate symbols provided. However, the invention is not particularly limited to the number of the rate symbols. In other words, a variety of types may be presented and the number to be displayed is not particularly limited.

### (Operation of the Controller 100)

In the followings, an operation of the controller 100 will be described. First, the scatter symbols and the rate symbols to be rearranged are determined by the rearrangement symbol determining unit 106, and the determined scatter symbols and the rate symbols to be rearranged are stored in the rearrangement symbol memory 105. The symbols and the rate symbols to be rearranged, which the rearrangement symbol memory 105 stores, are stored in the display symbol memory 107. The symbols and the rate symbols to be rearranged, which are stored in the display symbol memory 107, are enabled to be displayed in the display 101 by the display control unit 114. When a unit game is executed by the game executing unit 110, a variable display of the scatter symbols and the rate symbols is started and the scatter symbols and rate symbols to be rearranged, which are stored in the display symbol memory 107, are displayed in the display 101 at a timing at which a predetermined time has elapsed from the start of the variable display, so that the scatter symbols 180 and the rate symbols 181 are rearranged in the display windows 151 to 155. Thereby, the controller 100 executes a fifth process of rearranging the scatter symbols 180 and the rate symbols 181 in the display windows 151 to 155 based on a predetermined timing.

In addition, as described in the first embodiment, the controller 100 executes a second process of arranging the specific areas 190 in the display windows 151 to 155 based on a predetermined timing.

Then, a win is determined by the number of the scatter symbols 180 rearranged, and a prize which is obtained by multiplying the highest rate of the prize rates indicated by the rate symbols rearranged in the specific areas 190 with respect to the prize based on the win, is awarded by the prize determining unit 111 and the prize award unit 113. Thereby, the controller 100 executes a sixth process of awarding a prize according to prize rates, which are indicated by the rate symbols 181 rearranged in the display windows 151 to 155 in which the specific areas 190 are arranged, and the number of the scatter symbols 180 rearranged in the display windows 151 to 155.

As clearly seen from the above operations, the slot machine embodies a playing method including the steps of rearranging the scatter symbols 180 and the rate symbols 181 indicating the prize rates in the display windows 151 to 155 based on a predetermined timing; arranging the specific areas 190 in the display windows 151 to 155 based on a predetermined timing; and awarding a prize according to prize rates which are indicated by the rate symbols 181 rearranged in the display windows 151 to 155 in which the specific areas 190 are arranged, and the number of the scatter symbols 180 rearranged in the display windows 151 to 155.

According to the above playing method, in the display 101, the scatter symbols 180 and the rate symbols 181 indicting the prize rates are rearranged in the display windows 151 to 155 forming a matrix shape, and the specific areas 190 are arranged in the display windows 151 to 155, based on a predetermined timing. A prize according to prize rates which are indicated by the rate symbols 181 rearranged in the display windows 151 to 155 in which the specific areas 190 are arranged, and the number of the scatter symbols 180 rearranged in the display windows 151 to 155 is awarded.

Accordingly, by seeing the arrangement of the specific areas 190 and the rearrangement of the rate symbols 181 in the display windows 151 to 155 in which the specific areas 190 are arranged, a player can expect a new prize according to the prize rates indicated by the rate symbols 181 in the specific areas 190, so that a new entertainment characteristic can be provided.

### (Display State)

In the followings specifically describes an example of a display state of the display 101 during the operations of the slot machine 1 and the playing method thereof.

As same as the first embodiment, the display 101 scrolls zero to fifteen specific areas 190 after the scatter symbols 180 and the rate symbols 181 are scrolled, as shown in FIG. 4. Then, the display stops the scroll of the specific areas 190 and arranges the specific areas in the arrangement areas. To be more specific, as shown in FIG. 4, the specific areas 190 are arranged in the areas arrangement areas 151a, 152c, 153b, and 155c.

Then, as shown in FIG. 12, when the specific areas 190 are arranged in the display windows 151 to 155, the scroll of the scatter symbols 180 and the rate symbols 181 is stopped and the scatter symbols 180 and the rate symbols 181 are rearranged in the display windows 151 to 155.

Then, as shown in FIG. 12, a prize according to prize rates indicated by the rate symbols 181 rearranged in the display windows 151 to 155 in which the specific areas 190 are arranged, and the number of the scatter symbols 180 is awarded. To be more specific, a prize which is obtained by multiplying the highest rate of five times of the rates symbols 181a or 181c which are rearranged in the arrangement areas 152c and 153b in which the specific areas 190 are arranged, and the number of the scatter symbols 180, is awarded.

Like this, in the display, the scatter symbols and the rate symbols indicating the prize rates are rearranged and the specific areas are arranged in the arrangement areas based on a predetermined timing. Then, a prize according to prize rates indicated by the rate symbols rearranged in the arrangement areas in which the specific areas are arranged, and the number of the scatter symbols rearranged in the arrangement areas is awarded. Accordingly, by seeing the arrangement of the specific areas and the rearrangement of the rate symbols in the arrangement areas in which the specific areas are arranged, a player can expect a new prize according to the prize rates indicated by the rate symbols in the specific areas, so that a new entertainment characteristic can be provided.

### Third Embodiment

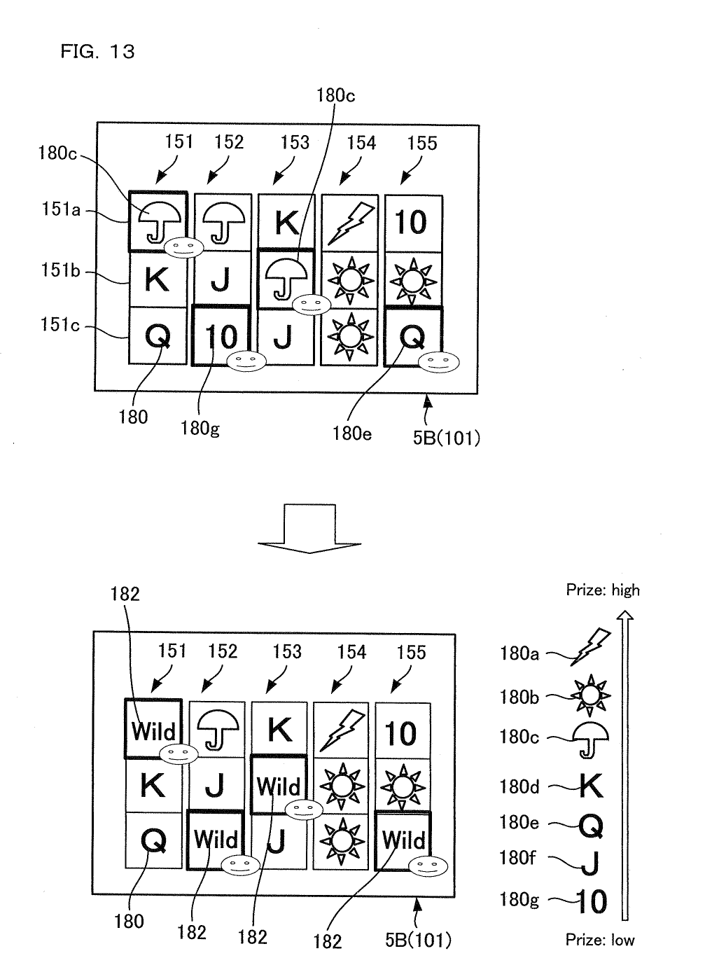

In the followings, a third embodiment of the slot machine and the playing method thereof according to the invention will be described with reference to FIG. 13. In the meantime, the members same as in the first embodiment are indicated with the same reference numerals.

As shown in FIG. 13, the slot machine executes a playing method including the steps of: rearranging one or more scatter symbols 180 based on a predetermined timing; arranging zero or more specific areas 190 in one or more display windows 151 to 155 based on a predetermined timing; replacing the one or more scatter symbols, which are rearranged in the one or more display windows 151 to 155 in which the zero or more specific areas 190 are arranged, with zero or more wild scatter symbols 182 indicating all scatter symbols 180; and awarding a prize according to the number of the scatter symbols 180 arranged in the one or more display windows 151 to 155.

Here, the “wild scatter symbol” is a scatter symbol indicating all scatter symbols and is a symbol that is treated as all the scatter symbols are displayed at the same time. The wild scatter symbol is a symbol included in the scatter symbols.

### (Display 101)

The slot machine executing the above playing method has a display 101 and a controller 100, as same as the first embodiment. The display 101 is configured to arrange scatter symbols 180 and wild scatter symbols 182.

### (Controller 100)

The controller 100 is structured to execute a first process of rearranging the scatter symbols 180 in the display windows 151 to 155 based on a predetermined timing; a second process of arranging the specific areas 190 in the display windows 151 to 155 based on a predetermined timing; a seventh process of replacing the scatter symbols 180, which are rearranged in the display windows 151 to 155 in which the specific areas 190 are arranged, with wild scatter symbols 182 indicating all scatter symbols 180; and a fourth process of awarding a prize according to the number of the scatter symbols 180 arranged in the display windows 151 to 155. In other words, the controller 100 has first, second, seventh and fourth processing units.

As same as the first embodiment, the controller 100 has a symbol memory 108, a display symbol memory 107, a rearrangement symbol determining unit 106, a rearrangement symbol memory 105, a display control unit 114, an arrangement specific area memory 116, a specific area memory 117, an arrangement specific area determining unit 118, a display specific area memory 115, a game executing unit 110, a prize determining unit 111, and a prize award unit 113.

The controller 100 executes a first process of rearranging the scatter symbols 180 in the display windows 151 to 155 based on a predetermined timing, and a second process of arranging the specific areas 190 in the display windows 151 to 155 based on a predetermined timing, like the first embodiment.

The display control unit 114 replaces the scatter symbols 180 rearranged in the display windows 151 to 155 in which the specific areas 190 are arranged, with wild scatter symbols 182 indicating all scatter symbols 180 after the execution of the first and second processes. In other words, the controller 100 executes a seventh process of replacing the scatter symbols 180 rearranged in the display windows 151 to 155 in which the specific areas 190 are arranged, with wild scatter symbols 182 indicating all scatter symbols 180.

Like the first embodiment, the prize determining unit 111 determines a prize that is determined by the number of the scatter symbols 180 arranged in the display windows 151 to 155 in a unit game. Then, the prize award unit 113 awards a prize based on a determination of the prize determining unit 111. In other words, the controller 100 executes a fourth process of awarding a prize according to the number of the scatter symbols 180 arranged in the display windows 151 to 155.

In the mean time, each block of the controller 100 may be structured with hardware or software, as required.

### (Operation of the Controller 100)

In the followings, the operation of the controller 100 will be described. First, as described in the first embodiment, the controller 100 executes a first process of rearranging the scatter symbols 180 in the display windows 151 to 155 based on a predetermined timing. Then, as described in the first embodiment, the controller 100 executes a second process of arranging the specific areas 190 in the display windows 151 to 155 based on a predetermined timing.

Then, the scatter symbols 180 rearranged in the display windows 151 to 155 in which the specific areas 190 are arranged, are replaced with the wild scatter symbols 182 and then displayed by the display control unit 114. Thereby, the controller 100 executes a seventh process of replacing the scatter symbols 180 rearranged in the display windows 151 to 155 in which the specific areas 190 are arranged, with wild scatter symbols 182 indicating all scatter symbols 180.

Then, as described in the first embodiment, the controller 100 executes a fourth process of awarding a prize according to the number of the scatter symbols 180 arranged in the display windows 151 to 155.

As clearly seen from the above operations, the slot machine 1 embodies a playing method including; the steps of rearranging the scatter symbols 180 based on a predetermined timing; arranging the specific areas 190 in the display windows 151 to 155 based on a predetermined timing; replacing the scatter symbols 180 rearranged in the display windows 151 to 155 in which the specific areas 190 are arranged, with the wild scatter symbols 182 indicating all scatter symbols 180; and awarding a prize according to the number of the scatter symbols 180 arranged in the display windows 151 to 155.

According to the above playing method, in the display, the scatter symbols are rearranged in the matrix having arrangement areas and the specific areas are arranged in the arrangement areas, based on a predetermined timing. The scatter symbols, which are rearranged in the arrangement areas in which the specific areas are arranged, are replaced with the wild scatter symbols indicating all scatter symbols and a prize according to the number of the scatter symbols arranged in the arrangement areas is awarded.

Accordingly, by seeing the arrangement of the specific areas and the rearrangement of the scatter symbols in the arrangement areas in which the specific areas are arranged, a player can expect a new prize resulting from the replacement of the scatter symbols in the specific areas with the wild scatter symbols, so that a new entertainment characteristic can be provided.

### (Display State)

In the followings, an example of a display state of the display 101 during the operations of the slot machine 1 and the playing method thereof will be specifically described.

As the first embodiment, as shown in FIG. 4, the display 101 scrolls zero to fifteen specific areas 190 from the right to the left direction when the scatter symbols 180 are scrolled. Then, the display stops the scroll of the specific areas 190 and arranges the specific areas in the arrangement areas. To be more specific, as shown in FIG. 4, the specific areas 190 are arranged in the arrangement areas 151a, 152c, 153b, and 155c.

Then, as shown in FIG. 13, when the specific areas 190 are arranged in the display windows 151 to 155, the scroll of the scatter symbols 180 is stopped and the scatter symbols 180 are rearranged in the display windows 151 to 155.

Then, as shown in FIG. 13, the scatter symbols 180, which are rearranged in the arrangement areas 151a, 152c, 153b, and 155c in which the specific areas 190 are arranged, are replaced with wild scatter symbols 182 indicating all scatter symbols.

Then, a prize according to the number of the replaced scatter symbols 180 (including the wild scatter symbols 182) is awarded. To be more specific, as shown in FIG. 13, a prize based on the number of the scatter symbols; e.g., five scatter symbols 180a seven scatter symbols 180b, five scatter symbols 180c, six scatter symbols 180d, five scatter symbols 180e, six scatter symbols 180f and five scatter symbols 180g. The number of the scatter symbols includes four wild scatter symbols 182.

Like this, the scatter symbols are rearranged and the specific areas are arranged in a matrix having the arrangement areas in the display based on a predetermined timing. The scatter symbols, which are rearranged in the arrangement areas in which the specific areas are arranged, are replaced with wild scatter symbols indicating all scatter symbols, and a prize according to the number of the scatter symbols arranged in the arrangement areas is awarded.

Accordingly, by seeing the arrangement of the specific areas and the rearrangement of the scatter symbols in the arrangement areas in which the specific areas are arranged, a player can expect a new prize resulting from the replacement of the scatter symbols in the specific areas with wild scatter symbols, so that a new entertainment characteristic can be provided.

### Fourth Embodiment

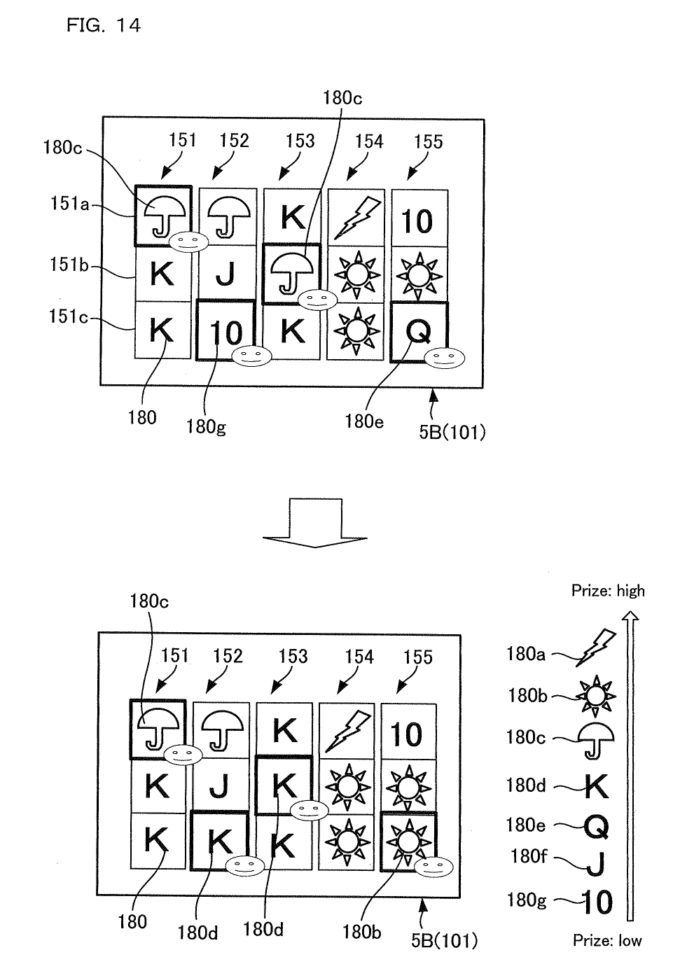

In the followings, a fourth embodiment of the slot machine and the playing method thereof according to the invention will be described with reference to FIG. 14. Meantime, the members same as in the first embodiment are indicated with the same reference numerals.

As shown in FIG. 14, the slot machine executes a playing method including the steps of; rearranging one or more scatter symbols 180 based on a predetermined timing; arranging zero or more specific areas 190 in one or more display windows 151 to 155 based on a predetermined timing; replacing the one or more scatter symbols 180 which are rearranged in the one or more display windows 151 to 155 in which the zero or more specific areas 190 are arranged, with the one or more scatter symbols 180 rearranged in the one or more adjacent arrangement areas in the one or more display windows 151 to 155, based on a predetermined condition; and awarding a prize according to the number of the scatter symbols 180 arranged in the one or more display windows 151 to 155.

### (Display 101)

The slot machine executing the above playing method has a display 101 and a controller 100, as same as the first embodiment. The display 101 is configured to arrange scatter symbols 180.

### (Controller 100)

The controller 100 is structured to execute a first process of rearranging the scatter symbols 180 in the display windows 151 to 155 based on a predetermined timing; a second process of arranging the specific areas 190 in the display windows 151 to 155 based on a predetermined timing; a eighth process of replacing the scatter symbols 180, which are rearranged in the display windows 151 to 155 in which the specific areas 190 are arranged, with the scatter symbols 180 rearranged in the adjacent arrangement areas, based on a predetermined condition; and a fourth process of awarding a prize according to the number of the scatter symbols 180 arranged in the display windows 151 to 155. In other words, the controller 100 has first, second, eighth and fourth processing units.

The controller 100 has a symbol memory 108, a display symbol memory 107, a rearrangement symbol determining unit 106, a rearrangement symbol memory 105, a display control unit 114, an arrangement specific area memory 116, a specific area memory 117, an arrangement specific area determining unit 118, a display specific area memory 115, a game executing unit 110, a prize determining unit 111 and a prize award unit 113, as same as the first embodiment.

The controller 100 executes a first process of rearranging the scatter symbols 180 in the display windows 151 to 155 based on a predetermined timing, and a second process of arranging the specific areas 190 in the display windows 151 to 155 based on a predetermined timing, as same as the first embodiment.

After the execution of the first and second processes, the display control unit 114 replaces the scatter symbols 180 rearranged in the display windows 151 to 155 in which the specific areas 190 are arranged, with the scatter symbols 180 rearranged in the adjacent arrangement areas when the same scatter symbols 180 are rearranged in the vertical or horizontal direction of the arrangement areas (specific areas) or combination thereof. In other words, when the same scatter symbols 180 are positioned in the vertical or horizontal direction of the arrangement areas (specific areas) and the scatter symbols of the specific areas are interposed between the same scatter symbols 180, the scatter symbols 180 of the specific areas are replaced with the same scatter symbols 180. In other words, the controller 100 executes a eighth process of replacing the scatter symbols 180 which are rearranged in the display windows 151 to 155 in which the specific areas 190 are arranged, with the scatter symbols 180 rearranged in the adjacent arrangement areas based on a predetermined condition.

Like the first embodiment, the prize determining unit 111 determines a prize that is determined by the number of the scatter symbols 180 arranged in the display windows 151 to 155 in a unit game. Then, the prize award unit 113 awards a prize based on a determination of the prize determining unit 111. In other words, the controller 100 executes a fourth process of awarding a prize according to the number of the scatter symbols 180 arranged in the display windows 151 to 155.

In the mean time, in this embodiment, the predetermined condition of replacing the scatter symbols in the eighth process means that the scatter symbols are replaced when the same scatter symbols are rearranged in the vertical or horizontal direction of the arrangement areas (specific areas) or combination thereof. However, the invention is not particularly limited thereto. For example, a scatter symbol may be replaced with a scatter symbol having the largest or smallest rearrangement-number, among the scatter symbols rearranged in the arrangement areas adjacent to the specific areas. Alternatively, the scatter symbol may be replaced with a scatter symbol that is rearranged in the arrangement area adjacent to a predetermined location of the specific area. In addition, a diagonal direction may be included in addition to the vertical and horizontal directions.

In the mean time, each block of the controller 100 may be structured with hardware or software as required.

### (Operation of the Controller 100)

In the followings, the operation of the controller 100 will be described. First, as described in the first embodiment, the controller 100 executes a first process of rearranging the scatter symbols 180 in the display windows 151 to 155 based on a predetermined timing. Then, as described in the first embodiment, the controller 100 executes a second process of arranging the specific areas 190 in the display windows 151 to 155 based on a predetermined timing.

Then, the scatter symbols 180 rearranged in the display windows 151 to 155 in which the specific areas 190 are arranged, are replaced with the scatter symbols 180 rearranged in the adjacent arrangement areas, when the same scatter symbols 180 are rearranged in the vertical or horizontal direction of the arrangement areas (specific areas) or combination thereof. Thereby, the controller 100 executes a eighth process of replacing the scatter symbols 180, which are rearranged in the display windows 151 to 155 in which the specific areas 190 are arranged, with the scatter symbols 180 rearranged in the adjacent arrangement areas, based on a predetermined condition.

Then, as described in the first embodiment, the controller 100 executes a fourth process of awarding a prize according to the number of the scatter symbols 180 arranged in the display windows 151 to 155.

As clearly seen from the above operations, the slot machine 1 embodies a playing method including the steps of; rearranging the scatter symbols 180 based on a predetermined timing; arranging the specific areas 190 in the display windows 151 to 155 based on a predetermined timing; replacing the scatter symbols 180 rearranged in the display windows 151 to 155 in which the specific areas 190 are arranged, with the scatter symbols 180 rearranged in the adjacent arrangement areas, based on a predetermined condition; and awarding a prize according to the number of the scatter symbols 180 arranged in the display windows 151 to 155.

According to the above playing method, in the display, the scatter symbols are rearranged in the matrix having arrangement areas, and the specific areas are arranged in the arrangement areas based on a predetermined timing. The scatter symbols rearranged in the arrangement areas in which the specific areas are arranged, are replaced with the scatter symbols rearranged in the adjacent arrangement areas based on a predetermined condition, and a prize according to the number of the scatter symbols arranged in the arrangement areas is awarded.

Accordingly, by seeing the arrangement of the specific areas and the rearrangement of the scatter symbols in the arrangement areas in which the specific areas are arranged, a player can expect a new prize resulting from the replacement of the scatter symbols in the specific areas with the scatter symbols in the adjacent arrangement areas, so that a new entertainment characteristic can be provided.

### (Display State)

In the followings, an example of a display state of the display 101 during the operations of the slot machine 1 and the playing method thereof will be specifically described.

As same as the first embodiment, as shown in FIG. 4, the display 101 scrolls zero to fifteen specific areas 190 from the right to the left direction after the scatter symbols 180 are scrolled. Then, the display stops the scroll of the specific areas 190 and arranges the specific areas in the arrangement areas. To be more specific, as shown in FIG. 4, the specific areas 190 are arranged in the arrangement areas 151a, 152c, 153b, and 155c.

Then, as shown in FIG. 14, when the specific areas 190 are arranged in the display windows 151 to 155, the scroll of the scatter symbols 180 is stopped and the scatter symbols 180 are rearranged in the display windows 151 to 155.

Then, as shown in FIG. 14, the scatter symbols 180 rearranged in the arrangement areas 151a, 152c, 153b, and 155c in which the specific areas 190 are arranged, are replaced with the scatter symbols 180 rearranged in the adjacent arrangement areas, when the same scatter symbols 180 are rearranged in the vertical or left and right direction of the arrangement areas (specific areas) or combination thereof. To be more specific, since the same scatter symbols 180 are not rearranged in the vertical or horizontal direction of the arrangement area 151a, the symbol in the arrangement area 151a is not replaced. In the mean time, since the scatter symbols 180d are rearranged in the horizontal direction of the arrangement area 152c, the scatter symbol 180g of the arrangement area 152c is replaced with a scatter symbol 180d. In addition, since the scatter symbols 180d are rearranged in the vertical direction of the arrangement area 153b, the scatter symbol 180c of the arrangement area 153b is replaced with a scatter symbol 180d. In addition, since the scatter symbols 180b are rearranged in the vertical and left directions of the arrangement area 155c, the scatter symbol 180e of the arrangement area 155c is replaced with a scatter symbol 180b.

Then, a prize according to the number of the replaced scatter symbols 180 is awarded. To be more specific, as shown in FIG. 14, a prize based on the number of the scatter symbols; e.g., one scatter symbol 180a, four scatter symbols 180b, two scatter symbols 180c, six scatter symbols 180d, zero scatter symbols 180e, one scatter symbol 180f and one scatter symbol 180g, is awarded.

Like this, the scatter symbols are rearranged, and the specific areas are arranged in the matrix having arrangement areas in the display based on a predetermined timing. Based on a predetermined condition, the scatter symbols rearranged in the arrangement areas in which the specific areas are arranged, are replaced with the scatter symbols that are rearranged in the adjacent arrangement areas and a prize according to the number of the scatter symbols arranged in the arrangement areas is awarded.

Accordingly, by seeing the arrangement of the specific areas and the rearrangement of the scatter symbols in the arrangement areas in which the specific areas are arranged, a player can expect a new prize resulting from the replacement of the scatter symbols in the specific areas with the scatter symbols in the adjacent arrangement areas, so that a new entertainment characteristic can be provided.

Although the above descriptions have been provided with regard to the characteristic parts so as to understand the invention more easily, the invention is not limited to the embodiment as described above and can be applied to the other embodiments and the applicable scope should be construed as broadly as possible. Furthermore, the terms and phraseology used in the specification have been used to correctly illustrate the invention, not to limit it. In addition, it will be understood by those skilled in the art that the other structures, systems, methods and the like included in the spirit of the invention can be easily derived from the spirit of the invention described in the specification. Accordingly, it should be considered that the invention covers equivalent structures thereof without departing from the spirit and scope of the invention as defined in the following claims. Further, the abstract is provided so that an intellectual property office and a general public institution or one skilled in the art who is not familiar with patent and legal or professional terminology can quickly analyze the technical features and essences of the invention through a simple investigation. Accordingly, the abstract is not intended to limit the scope of the invention that should be evaluated by the claims. In addition, it is suggested to sufficiently refer to the documents that have been already disclosed, so as to fully understand the objects and effects of the invention.

The above descriptions include a process that is executed on a computer or computer network. The above descriptions and expressions have been provided so that the one skilled in the art can understand the invention most effectively. In the specification, the respective steps used to induce one result or blocks having a predetermined processing function should be understood as a process having no self-contradiction. In addition, the electrical or magnetic signal is transmitted/received and written in the respective steps or blocks. Although the processes in the respective steps or blocks embody the signal as a bit, value, symbol character, term, number and the like, it should be noted that these have been used for the convenience of descriptions. Further, although the processes in the respective steps or blocks have been often described as an expression common to a human action, the process described in the specification is executed by a variety of devices in principle. In addition, the other structures necessary for the respective steps or blocks are apparent from the above descriptions.

What is claimed is:

1. A gaming machine comprising:
a display that has a matrix having one or more arrangement areas and arranges one or more scatter symbols and zero or more specific areas in the one or more arrangement areas; and
a controller operates:
(a1) to rearrange the one or more scatter symbols based on a predetermined timing;
(a2) to arrange the zero or more specific areas based on a predetermined timing; and
(a3) to award a prize according to the one or more scatter symbols which are rearranged in the one or more arrangement areas in which the zero or more specific areas are arranged, and the number of the scatter symbols rearranged in the one or more arrangement areas.

2. A gaming machine comprising:
a display that has a matrix having one or more arrangement areas and arranges one or more scatter symbols and zero or more specific areas in the one or more arrangement areas, the one or more scatter symbols each indicating a prize of different magnitude; and
a controller operates:
(b1) to rearrange the one or more scatter symbols based on a predetermined timing;
(b2) to arrange the zero or more specific areas based on a predetermined timing;
(b3) to replace the one or more scatter symbols, which are rearranged in the one or more arrangement areas in which the zero or more specific areas are arranged, with one or more scatter symbols indicating prizes of predetermined magnitudes; and
(b4) to award a prize according to the number of the scatter symbols arranged in the one or more arrangement areas.

3. A gaming machine comprising:
a display that has a matrix having one or more arrangement areas and arranges one or more scatter symbols, zero or more rate symbols each of which indicating a prize rate, and zero or more specific areas in the one or more arrangement areas; and
a controller operates:
(c1) to rearrange the one or more scatter symbols and the zero or more rate symbols based on a predetermined timing;
(c2) to arrange the zero or more specific areas based on a predetermined timing; and
(c3) to award a prize according to prize rates which are indicated by the zero or more rate symbols rearranged in the one or more arrangement areas in which the zero or more specific areas are arranged, and the number of the scatter symbols rearranged in the one or more arrangement areas.

4. A gaming machine comprising:
a display that has a matrix having one or more arrangement areas and arranges one or more scatter symbols and zero or more specific areas in the one or more arrangement areas; and
a controller operates:
(d1) to rearrange the one or more scatter symbols based on a predetermined timing;
(d2) to arrange the zero or more specific areas based on a predetermined timing;
(d3) to replace the one or more scatter symbols, which is rearranged in the one or more arrangement areas in which the zero or more specific areas are arranged, with zero or more wild scatter symbols; and
(d4) to award a prize according to the number of the one or more scatter symbols arranged in the one or more arrangement areas.

5. A gaming machine comprising:
a display that has a matrix having one or more arrangement areas and arranges one or more scatter symbols and zero or more specific areas in the one or more arrangement areas; and
a controller operates:
(e1) to rearrange the one or more scatter symbols based on a predetermined timing;
(e2) to arrange the zero or more specific areas based on a predetermined timing;
(e3) to replace the one or more scatter symbols, which are rearranged in the one or more arrangement areas in which the zero or more specific areas are arranged, with one or more scatter symbols rearranged in the one or more adjacent arrangement areas, based on a predetermined condition; and
(e4) to award a prize according to the number of the scatter symbols arranged in the one or more arrangement areas.

6. A playing method of a gaming machine in which one or more scatter symbols and zero or more specific areas are arranged in one or more arrangement areas in a matrix in a display, the method comprising the steps of:
(f1) rearranging the one or more scatter symbols based on a predetermined timing;
(f2) arranging the zero or more specific areas based on a predetermined timing; and
(f3) awarding a prize according to the one or more scatter symbols, which are rearranged in the one or more arrangement areas in which the zero or more specific areas are arranged, and the number of the scatter symbols rearranged in the one or more arrangement areas.
